(19) United States
(12) Patent Application Publication
(10) Pub. No.: US 2003/0206343 A1
(43) Pub. Date: Nov. 6, 2003

(54) Stereoscopic image display apparatus and stereoscopic image display system

(76) Inventors: Hideki Morishima, Tochigi (JP); Toshiyuki Sudo, Tochigi (JP); Hiroshi Nishihara, Tokyo (JP)

Correspondence Address: MORGAN & FINNEGAN, L.L.P., 345 PARK AVENUE, NEW YORK, NY, 10154, US

(21) Appl. No.: 10/421,427

(22) Filed: Apr. 23, 2003

(30) Foreign Application Priority Data
Apr. 24, 2002 (JP) 2002-122993
Apr. 10, 2003 (JP) 2003-106557

(51) Int. Cl. G02B 27/22

(52) U.S. Cl. 359/463

(57) ABSTRACT

The present invention discloses a multiviewpoint stereoscopic image display apparatus for which an image display unit can be freely selected without limiting to a transmissive image display unit, and in which crosstalk doesn't arise. This stereoscopic image display apparatus includes an image display unit in which a plurality of horizontal pixel lines is provided in a vertical direction, and pixel groups including pixels that display images corresponding to a plurality of observation positions respectively are arranged cyclically. And the apparatus also includes a mask member in which apertures to pass only a ray having predetermine directionality from the pixels are formed. Then, the apparatus includes a limiting member that limits rays from a predetermined horizontal pixel line may reach only horizontal aperture lines having the apertures whose horizontal positions are the same.

### BACKGROUND OF THE INVENTION

1. Field of the Invention

The present invention relates to a stereoscopic (three-dimensional) image display apparatus, and in particular, to a stereoscopic image display apparatus suitable for performing stereoscopic display in a TV set, a VTR, a computer monitor, a game machine, and the like.

2. Description of the Related Art

As a stereoscopic image display apparatus, there is, for example, a so-called multiple lens system proposed in published European Patent Application No. 1 248 473(A1).

This stereoscopic image display apparatus expresses the stereoscopic effects by displaying many original images of a certain observation object, which is three-dimensionally seen, corresponding to observation positions (viewpoints) on an image display unit, and leading light from the image display unit so as to be able to observe these original images from different viewpoints respectively.

Nevertheless, this conventional stereoscopic image display apparatus has following problems.

(1) Since it is necessary to use a transmissive display as an image display unit that displays the original images to be three-dimensionally seen, degrees of freedom of display unit selection are lowered.

In addition, though LCDs are widely used now as transmissive display units, a recent LCD tends to largely scatter illumination light when the illumination light penetrates the LCD because pixel structure is made fine so as to improve a viewing angle characteristic. Therefore, so as to use such an LCD for a multiviewpoint stereoscopic image display apparatus, it is necessary to specify a direction of display light at a position where is apart by desired observation distance from the display unit so that the display light reaches only the observation positions corresponding to the respective pixels.

At this point, the above-described conventional stereoscopic image display apparatus has the structure that gives directionality to the illumination light that illuminates pixels of the transmissive display unit. Nevertheless, when the diffusion of the LCD increases, there arises a problem that, since the LCD scatters the illumination light even if the directionality is given to the illumination light, arrival positions of the illumination light in an observation plane shift, and hence, and stereoscopic images cannot be properly observed because a so-called crosstalk arises.

(2) The structure of the conventional stereoscopic image display apparatus has a problem that, when performing color display, there is no position where it is possible to observe a color image since colors are separated on an observation plane by the color filter arrangement of the LCD.

### SUMMARY OF THE INVENTION

The present invention aims to provide a multiviewpoint stereoscopic image display apparatus for which an image display unit can be freely selected without limiting to a transmissive image display unit, and in which crosstalk doesn't occur even if a transmissive image display unit with strong scattering is used.

In order to achieve the above-described object, a stereoscopic image display apparatus according to the present invention includes an image display unit in which a plurality of horizontal pixel lines is provided in a vertical direction, and pixel groups including pixels that display images corresponding to a plurality of observation positions respectively are arranged cyclically; a mask member in which apertures to pass only a ray of light having predetermined directionality, among rays of light from the pixels are formed, and the apertures form horizontal aperture lines having predetermined cycle in a horizontal direction corresponding to the pixel groups. And the apparatus also includes a limiting member that limits rays of light so that rays of light from a predetermined horizontal pixel line among the horizontal pixel lines may reach only horizontal aperture lines having the apertures whose horizontal positions are the same. Then, rays of light from the pixels that display images corresponding to the respective observation positions reach predetermined observation positions through the mask member and the limiting member.

Features of the present invention will become clear by the description of specific embodiments with referring to the following drawings.

### BRIEF DESCRIPTION OF THE DRAWINGS

FIG. 1 is a perspective view showing the structure of a stereoscopic image display apparatus that is Embodiment 1 of the present invention.

FIG. 2 is a front view showing the pixel arrangement of a display unit used for the stereoscopic image display apparatus according to Embodiment 1.

FIG. 3 is a front view showing the aperture arrangement of a mask used for the stereoscopic image display apparatus according to Embodiment 1.

FIG. 4 is a perspective view showing optical paths on which display light from pixels in the stereoscopic image display apparatus according to Embodiment 1 reaches observation positions.

FIG. 5 is a sectional view taken on a plane passing a horizontal pixel line ld1 and a horizontal aperture line lm1 of the stereoscopic image display apparatus in FIG. 4.

FIG. 6 is a sectional view taken on a plane passing a horizontal pixel line ld2 and a horizontal aperture line lm2 of the stereoscopic image display apparatus in FIG. 4.

FIG. 7 is a sectional view taken on a plane passing a horizontal pixel line ld3 and a horizontal aperture line lm3 of the stereoscopic image display apparatus in FIG. 4.

FIG. 8 is a top view showing a state that rays of display light from horizontal pixel lines ld1, ld2, and ld3 in the stereoscopic image display apparatus according to Embodiment 1 reach observation positions.

FIG. 9 is a vertical section of the stereoscopic image display apparatus according to Embodiment 1.

FIG. 10 is a front view showing the subpixel arrangement of a color display unit used for a stereoscopic image display apparatus according to Embodiment 2 of the present invention.

FIG. 11 is a front view showing the pixel arrangement of a display unit used for a stereoscopic image display apparatus according to Embodiment 3 of the present invention.

FIG. 12 is a front view showing the aperture arrangement of a mask used for a stereoscopic image display apparatus according to Embodiment 3.

FIG. 13 is a perspective view showing the structure of a stereoscopic image display apparatus that is Embodiment 4 of the present invention.

FIG. 14 is a front view showing the pixel arrangement of a display unit used for a stereoscopic image display apparatus according to Embodiment 4.

FIG. 15 is a sectional view taken on a plane passing a horizontal pixel line ld1 and a horizontal aperture line lm1 of the stereoscopic image display apparatus in FIG. 14.

FIG. 16 is a sectional view taken on a plane passing a horizontal pixel line ld2 and a horizontal aperture line lm2 of the stereoscopic image display apparatus in FIG. 14.

FIG. 17 is a sectional view taken on a plane passing a horizontal pixel line ld3 and a horizontal aperture line lm3 of the stereoscopic image display apparatus in FIG. 14.

FIG. 18 is a top view showing a state that rays of display light from horizontal pixel lines ld1, ld2, and ld3 in the stereoscopic image display apparatus according to Embodiment 4 reach observation positions.

FIG. 19 is a front view showing the aperture arrangement of a mask used for the stereoscopic image display apparatus according to Embodiment 4.

FIG. 20 is a perspective view showing the structure of a stereoscopic image display apparatus that is Embodiment 5 of the present invention.

FIG. 21 is a vertical section of the stereoscopic image display apparatus according to Embodiment 5.

FIG. 22 is a perspective view showing the structure of a stereoscopic image display apparatus that is Embodiment 6 of the present invention.

FIG. 23 is a front view showing the pixel arrangement of a display unit used for a stereoscopic image display apparatus according to Embodiment 7 of the present invention.

FIG. 24 is a front view showing the aperture arrangement of a mask used for the stereoscopic image display apparatus according to Embodiment 7.

FIG. 25 is a sectional view taken in a plane passing a horizontal pixel line ld1 and a horizontal aperture line lm1 of a mask of a display unit in the stereoscopic image display apparatus according to Embodiment 7.

FIG. 26 is a sectional view taken in a plane passing a horizontal pixel line ld2 and a horizontal aperture line lm2 of a mask of the display unit in stereoscopic image display apparatus according to Embodiment 7.

FIG. 27 is a top view showing a state that rays of display light from horizontal pixel lines ld1, and ld2 in the stereoscopic image display apparatus according to Embodiment 7 reach observation positions.

FIG. 28 is a vertical section of the stereoscopic image display apparatus according to Embodiment 7.

FIG. 29 is a front view of a display unit having delta type pixel arrangement that can be used for each of the above-described Embodiments.

### DETAILED DESCRIPTON OF THE PREFERRED EMBODIMENTS

Hereafter, embodiments of the present invention will be explained with referring to drawings.

(Embodiment 1)

This Embodiment relates to a stereoscopic image display apparatus having a number of viewpoints (number of observation positions) of r, and in particular, to a stereoscopic image display apparatus where the degradation of resolution in a vertical direction and a horizontal direction is not biased in either direction by arranging pixel groups each arranged in the matrix of r=p pieces (rows)×q pieces (columns).

Here, p and q are integers that are one or more. In particular, in the case of p=1, the above-described matrix is composed of one horizontal line of pixels displaying images corresponding to respective observation positions. In addition, in particular, in the case of q=1, the above-described matrix is composed of one vertical line of pixels displaying images corresponding to respective observation positions. Depending on a number of viewpoints, r, it is possible to regard pixels as ones having different p and q as the size of the above-described matrix even if pixel arrangement is the same. For example, in the case of r=12, it may be possible to regard them as (P, q)=(1, 12), (2.6), (3, 4), (4, 3), (6, 2), (12, 1), or the like. According to each case, the structure of each portion constituting a stereoscopic image display apparatus explained later is determined.

In addition, a stereoscopic image display apparatus having nine viewpoints composed of p=3, q=3, and r=9 will be explained in this embodiment. However, numbers of p, q, and r in the present invention is not limited to the above-described values, but it is possible to select other numbers arbitrarily.

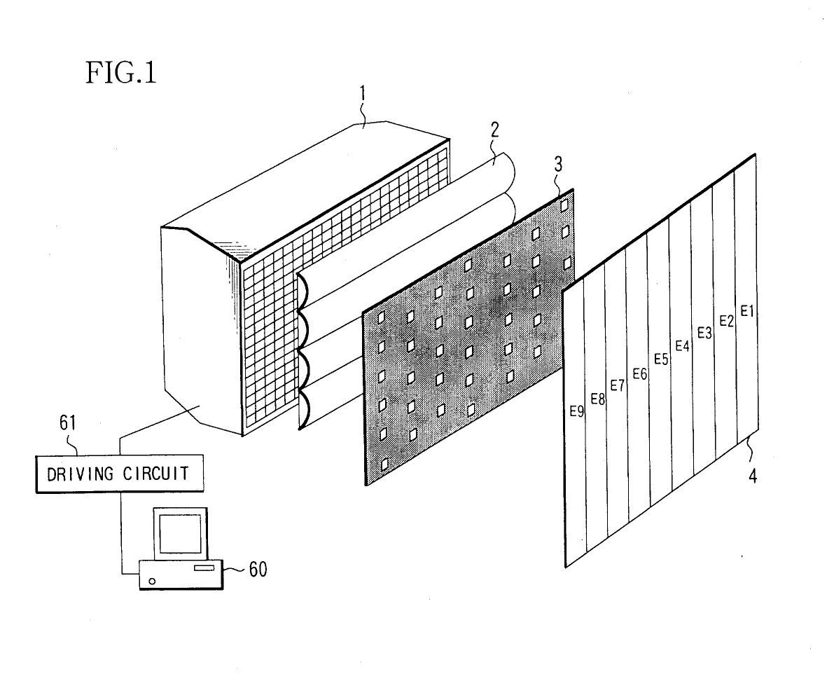

FIG. 1 shows the structure of a stereoscopic image display apparatus that is Embodiment 1 of the present invention. This stereoscopic image display apparatus is constituted by a monochrome display unit 1 as an image display unit, a horizontal lenticular lens 2 (limiting member) arranged in front of this display unit 1, and a mask 3 arranged in front of this horizontal lenticular lens 2, which are arranged in this order from the display unit 1 toward an observation plane 4 where observation positions (viewpoints) E1 to E9 are lined up.

This embodiment is a stereoscopic image display apparatus that makes it possible to observe different images from nine viewpoints respectively. Nine observation positions E1 to E9 on the observation plane 4 are lined up from the right to the left in the order of, for example, E1 to E9. In addition, the observation positions concerned do not mean one point, but mean an area having a certain degree of horizontal width.

As the display unit 1, it is possible to use a reflective or transmissive LCD, a self-light-emitting display device, and the like without limiting to a transmissive display.

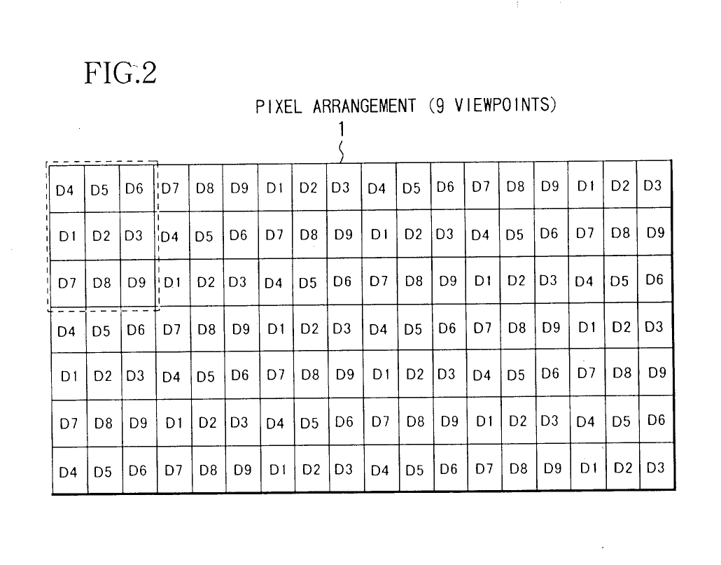

FIG. 2 shows how original images observed from nine viewpoints respectively are displayed by the respective pixels of the display unit 1. The pixels from D1 to D9 display the original images corresponding to the observation positions from E1 to E9 respectively.

Here, the image information to display the above-described original images in the display unit 1 is supplied from an image information supplying apparatus 60 such as a personal computer, a VCR, and a DVD drive to a display unit driving-circuit 61 of the stereoscopic image display apparatus, and the above-described original images are displayed by the display unit driving-circuit 61 driving the display unit 1 on the basis of the inputted image information.

In a pixel arrangement method, it is made to repeatedly arrange the pixels from D1 to D9 corresponding to the nine (=r) viewpoints in each horizontal line of pixels (hereafter, this line is called a horizontal pixel line) in this order cyclically, and to make horizontal positions of the pixels from D1 to D9 shift by three (=q) pixels every other horizontal pixel line in the vertical direction and also to make pixel arrangement become the same every three horizontal pixel lines in the vertical direction.

Owing to this, each pixel block that is enclosed by dotted lines in FIG. 2 is formed by arranging nine pixels from D1 to D9 in a matrix of three pixel (rows)×three pixels (columns), and the display unit 1 is formed in a shape that a plurality of these pixel blocks is arranged vertically and horizontally.

However, in regard to the arrangement of the above-described nine pixels in each pixel block, there are a type of arranging pixels D1 to D3 in a top portion, a type of arranging pixels D4 to D6 in a top portion, and a type of arranging pixels D7 to D9 in a top portion.

Then, nine images corresponding to the nine viewpoints are displayed by using an individual pixel in each of these plural pixel blocks. Thereby, a pixel group of D1, a pixel group of D2, a pixel group of D3, a pixel group of D4, a pixel group of D5, a pixel group of D6, a pixel group of D7, a pixel group of D8, and a pixel group of D9 are formed.

Here, the above-described nine images may as well be nine images corresponding to images at the time when a certain observation object is seen with changing a direction (observation position), or, for example, an image group seen at the time of seeing the display unit 1 from the left side and an image group seen at the time of seeing it from the right side may as well be made to be images of different observation objects.

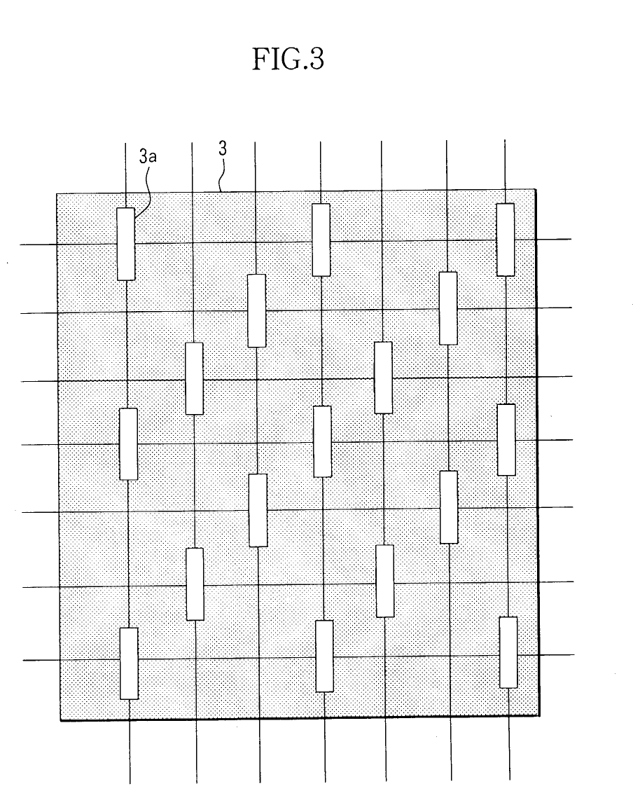

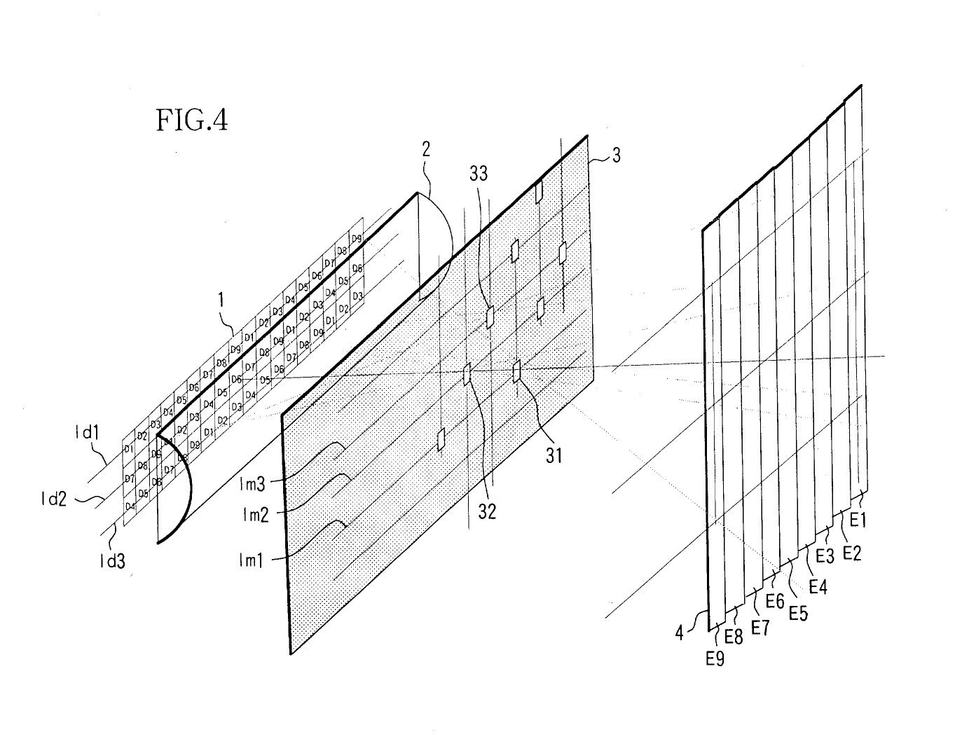

Next, an aperture pattern of the mask 3 and a principle of the nine-viewpoint stereoscopic image indication will be explained by using FIGS. 3 and 4.

Each cylindrical lens portion constituting the horizontal lenticular lens 2 corresponds to p (=3) lines of horizontal pixel lines on the display unit 1, and in FIG. 4, only a cylindrical lens portion corresponding to three lines of horizontal pixel lines is shown. As for the vertical direction, rays of display light from three horizontal pixel lines ld1, ld2, and ld3 are formed images on horizontal lines lm1, lm2, and lm3 (hereafter, these are called horizontal aperture lines) of apertures (in FIG. 3, these are shown as 3a) on the mask 3 respectively by the horizontal cylindrical lens 2.

The display light emerged from pixels D1 to D9 in the horizontal pixel line ld1 is collected in the horizontal aperture line lm1 on the mask 3 by the horizontal lenticular lens 2, and only the display light that passes an aperture 31 on the horizontal aperture line lm1 reaches the observation plane 4. At this time, the rays of display light emerged from the pixels D1 to D9 reach the observation positions E1 to E9 on the observation plane 4 respectively, but don't reach other observation positions because of being shielded by a light shielding portion that is a portion other than apertures in the mask 3.

Pixels D1 to D9 on the horizontal pixel line ld2, as shown in FIGS. 2 and 4, shifts horizontally by three (=q) pixels to the pixels D1 to D9 on the horizontal pixel line ld1. Then, the display light emerged from the pixels D1 to D9 on the horizontal pixel line ld2 is collected in the horizontal aperture line lm2 on the mask 3 by the horizontal lenticular lens 2, and only the display light passing an aperture 32 on this horizontal aperture line lm2 reaches the observation plane. A horizontal position of the aperture 32 shifts by a predetermined amount to the aperture 31 as described later in detail. Hence, rays of display light emerged from the pixels D1 to D9 on the horizontal pixel line ld2 reach the observation positions E1 to E9 of the observation plane 4 respectively through the aperture 32, but do not reach other observation positions because of being shielded by the light shielding portion of the mask 3.

Similarly, pixels D1 to D9 on the horizontal pixel line ld3 also horizontally shift by three (=q) pixels to the pixels D1 to D9 on the horizontal pixel line ld2. Then, rays of display light emerged from the pixels D1 to D9 on the horizontal pixel line ld3 are collected in the horizontal aperture line lm3 on the mask 3 by the horizontal lenticular lens 2, and only the display light passing an aperture 33 on the horizontal aperture line lm3 reaches the observation plane 4. A horizontal position of the aperture 33 shifts by a predetermined amount to the aperture 32 (owing to this, the apertures 31, 32, and 33 are arranged with horizontally shifting mutually). Hence, the rays of display light emerged from the pixels D1 to D9 on the horizontal pixel line ld3 reaches the observation positions E1 to E9 of the observation plane 4 respectively through the aperture 33, but do not reach other observation positions because of being shielded by the light shielding portion of the mask 3.

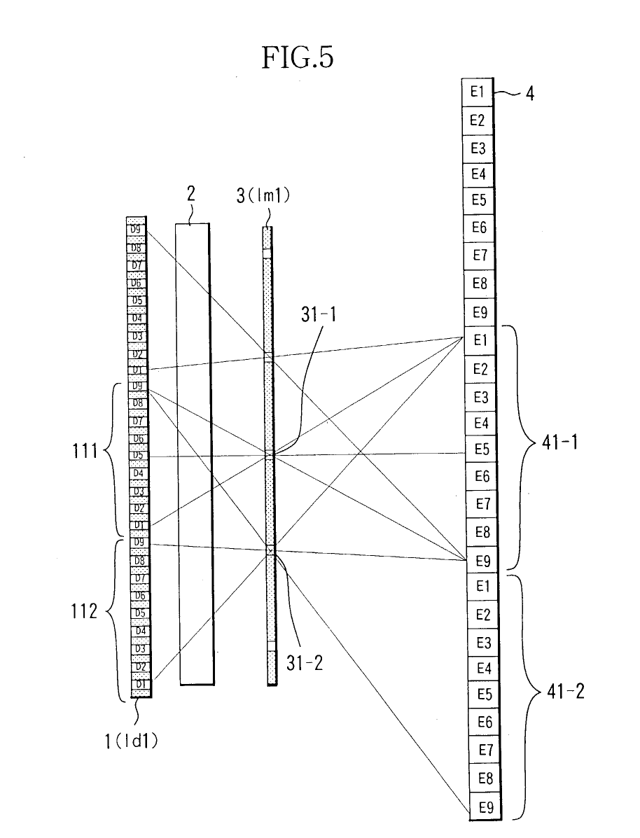

FIGS. 5 to 7 show the operation of the stereoscopic image display apparatus according to this embodiment to a horizontal luminous flux in further detail. FIGS. 5, 6, and 7 show sections taken on planes passing the horizontal pixel line ld1 and horizontal aperture line lm1, the horizontal pixel line ld2 and horizontal aperture line lm2, and the horizontal pixel line ld3 and horizontal aperture line lm3 in FIG. 4 respectively, and common numerical characters are assigned to components common to those in FIG. 4.

This embodiment operates similarly to a usual nine-viewpoint parallax barrier method in this section.

In FIG. 5, rays of display light from pixels D1 to D9 arranged in a consecutive area 111 in the horizontal pixel line ld1 on the display unit 1 pass an aperture 31-1 in the mask 3, and reach the corresponding observation positions E1 to E9 in a consecutive area 41-1 on the observation plane 4. Nevertheless, the rays of display light cannot reach observation positions, which do not correspond, because of being shielded by the light shielding portion of the mask 3.

Similarly, rays of display light from pixels D1 to D9 arranged in a consecutive area 112 in the horizontal pixel line ld1 pass an aperture 31-2 of the mask 3, and reach the corresponding observation positions E1 to E9 in a consecutive area 41-2 on the observation plane 4. Nevertheless, the rays of display light cannot reach observation positions, which do not correspond, because of being shielded by the light shielding portion of the mask 3.

The rays of light that are emerged from respective pixels in the area 111 on the display unit 1 and pass apertures other than the aperture 31-1 of the mask 3, for instance, the aperture 31-2 reach the observation positions E1 to E9, which are arranged to be the same as the viewpoint positions E1 to E9 in the area 41-1, in the consecutive area 41-2 that is different from the area 41-1 (that is, another area corresponding to the area 111) on the observation plane 4. In addition, the rays of display light passing apertures other than the apertures 31-1 and 31-2 also reaches similar observation positions in other areas on the observation plane 4.

Thus, the rays from respective pixels D1 to D9 corresponding to nine viewpoints on the display unit 1 not only reach the observation positions E1 to E9 in the area 41-1 on the observation plane 4 respectively, but also reach the observation positions E1 to E9 in the areas other than the area 41-1 on the observation plane 4 respectively.

That is, in consequence, the nine observation positions E1 to E9 (nine viewpoints) where the rays from respective pixels D1 to D9 in the horizontal pixel line lm1 of the display unit 1 reach respectively are repeatedly formed horizontally on the observation plane 4.

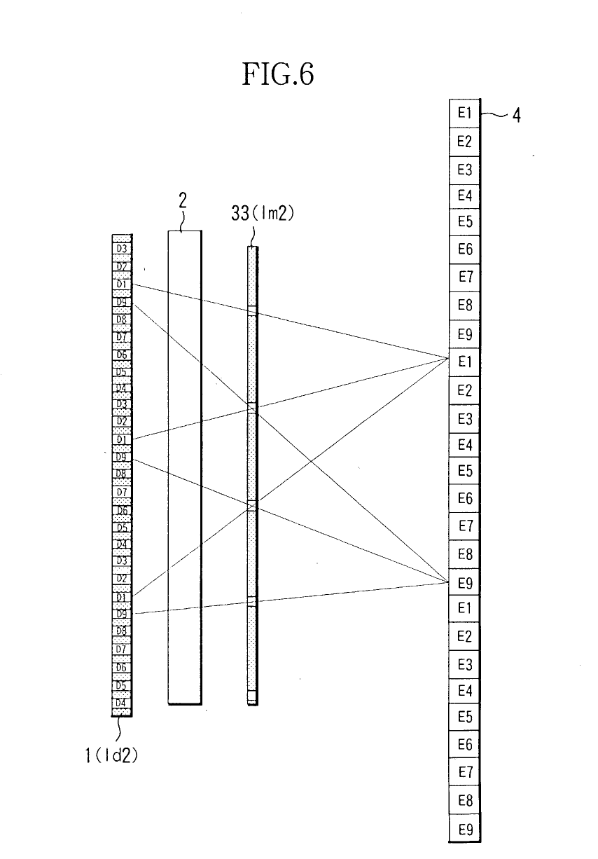

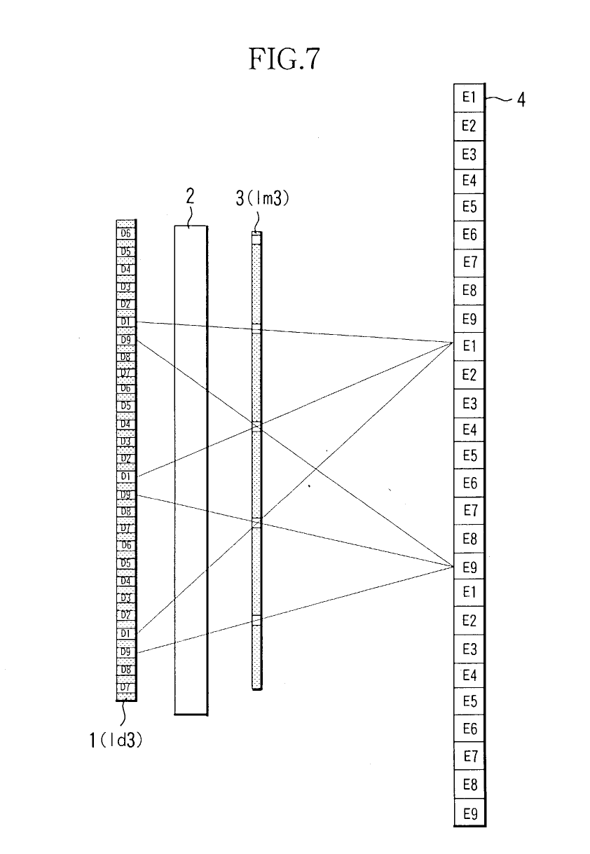

In the sections that are the planes passing the horizontal pixel lines ld2 and ld3 on the display unit 1, and the horizontal aperture lines lm2 and lm3 on the mask 3, which are shown in FIGS. 6 and 7, the rays from the respective pixels D1 to D9 in the display unit 1 reach the observation positions E1 to E9 on the observation plane 4 respectively. Similarly to the state in the section explained in FIG. 5, the nine observation positions E1 to E9 are horizontally formed on the observation plane 4 repeatedly.

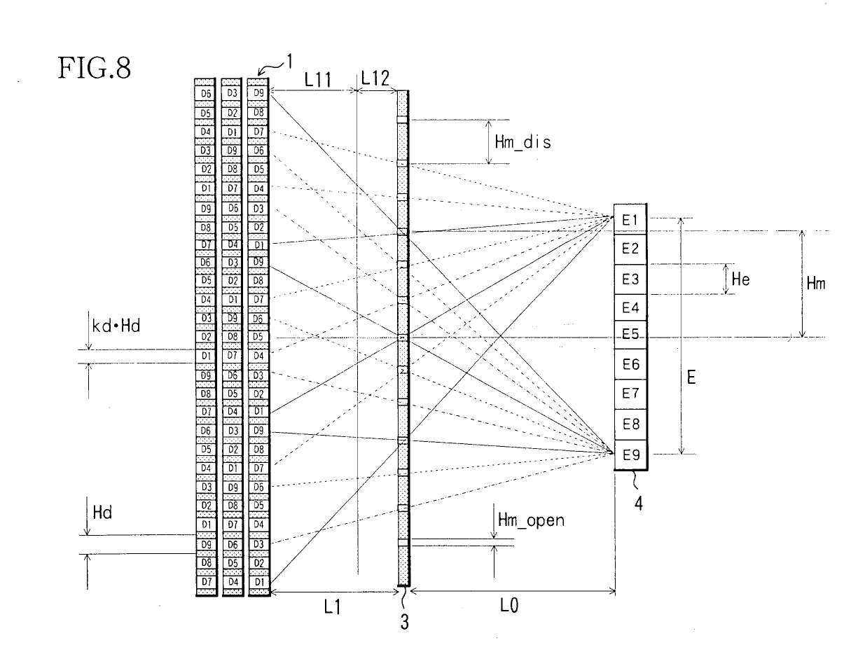

FIG. 8 shows the sections shown in FIGS. 5 to 7 with superimposing them, and the three horizontal pixel lines ld1, ld2, and ld3 of the display unit 1 are shown with being mutually shifted longitudinally.

Here, relational expressions among horizontal parameters concerning stereoscopic image display will be explained by using FIGS. 5 to 8. In addition, the number of viewpoints is generalized as r=p·q in this relational expression. Furthermore, the horizontal lenticular lens 2 is omitted in FIG. 8.

When that a horizontal pixel pitch of the display unit 1 is Hd, an interval between apertures in the same horizontal aperture line in the mask 3 is Hm, the horizontal width of an aperture is Hm_open, a horizontal shift amount of an aperture each time a horizontal aperture line is different by one line in the vertical direction is Hm_dis, air conversion distance between the display unit 1 and mask 3 is L1, air conversion distance between the mask 3 and observation plane 4 is L0, separation width between observation positions E1 and Er corresponding to pixels D1 and Dr (r=9 in this embodiment) is E, and each horizontal width of observation positions E1 to Er is He, the following four relational expressions h1 to h4 stand up by using fundamental geometrical relations:

| | |
|---|---|
| (r − 1) · Hd:(r − 1) · He = L1:L0 | (h1) |
| r · Hd:Hm = L1 + L0:L0 | (h2) |
| He · (r − 1) = E | (h3) |
| Hm_dis:Hd · q = L0:L1 + L0 | (h4) |

Moreover, in addition to the above-described expressions h1 to h4, it is required to satisfy the following expressions in order that rays of display light from pixels D1 to Dr are accommodated within the observation positions E1 to Er on the observation plane 4 respectively not to leak to adjacent observation positions:

| | |
|---|---|
| kd · Hd:He = L11:L12 + L0 | (h5) |
| kd · Hd:Hm_open = L11:L12 | (h6) |
| L1 + L12 = L1 | (h7) |

Here, L11 and L12 are optical conversion distance from the display unit 1 and optical conversion distance from the mask 3 to a point where straight lines connecting both ends of an effective portion (when a horizontal aperture ratio of a pixel is kd, width is kd·Hd) of each pixel on the display unit 1 to both ends of an observation position (width: He) corresponding to one viewpoint on the observation plane 4 intersect with each other.

When independent variables are L0, Hd, E, kd, p, q, and r (=p·q), solutions of these relational expressions are as follows:

L1=Hd·L0·(r−1)/E

He=E/(r−1)

Hm=r·Hd·E/((r−1)·Hd+E)

Hm_dis=E·Hd·q/((r−1)·Hd+E)

Hm_open=(1−kd)·Hd·E/((r−1)·Hd+E)

For example, when Hd=0.3 mm, kd=0.7, L0=600 mm, p=3, q=3, r=9, and E=200 mm:

L1=7.2 mm

He=25 mm

Hm=2.668 mm

Hm_dis=0.889 mm

Hm_open=0.0889 mm

Next, the operation of the horizontal lenticular lens 2 in this embodiment will be explained. This embodiment leads display light from each horizontal pixel line of the display unit 1 to a corresponding horizontal aperture line in the mask 3, and leads the light from pixels D1 to D9 arranged in a matrix in a pixel block by a horizontal aperture line where horizontal positions of apertures shift every line so that nine vertically-striped areas (nine observation positions) being lined up horizontally on the observation plane 4 may be formed.

When the display light emerged from each horizontal pixel line leaks into a horizontal aperture line on mask 3 that doesn't correspond (that is, a horizontal aperture line other than horizontal aperture lines in which the apertures thereof are disposed at the same positions in the horizontal direction), a crosstalk arises. The horizontal lenticular lens 2 operates as a limiting member to suppress this crosstalk.

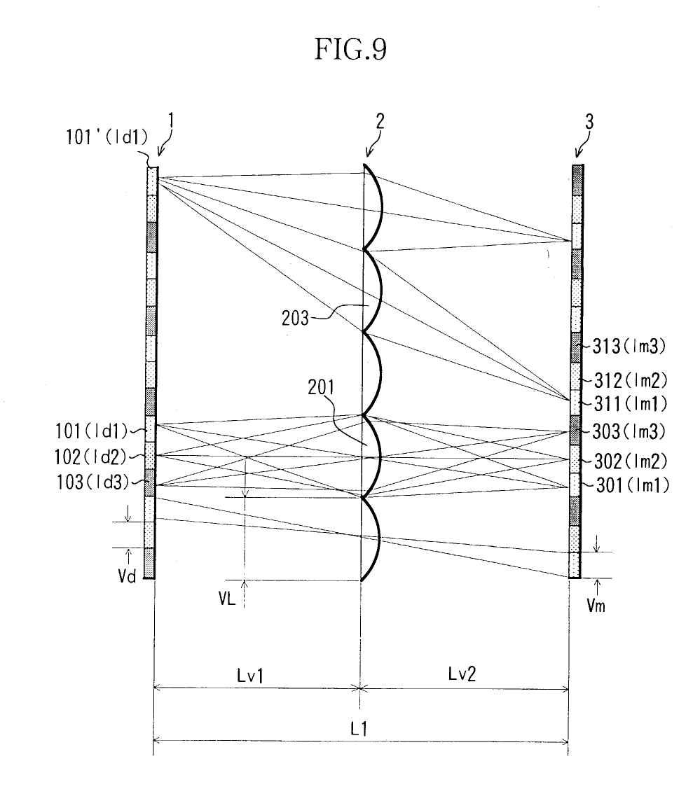

FIG. 9 is a vertical section of the stereoscopic image display apparatus according to this embodiment, and the same reference characters are assigned to components common to those shown in the above-described drawings.

The horizontal lenticular lens 2 is constituted by vertically arranging a plurality of cylindrical lens portions that have optical power (an optical power is a reciprocal of a focal length) only in the vertical direction but do not have optical power in the horizontal direction. Since pixel blocks each having the size of q=3 and p=3 in horizontal and vertical directions respectively are disposed in the display unit in this embodiment, one cylindrical lens portion is provided in regard to the vertical direction with corresponding to three (=p) lines of horizontal pixel lines lined up in the vertical direction on the display unit 1. Owing to this, one cylindrical lens portion has an action making the light emerged from these horizontal pixel lines form images on the three corresponding horizontal aperture lines on the mask 3.

Owing to this, the display light emerged from each horizontal pixel line on the display unit 1 is led to a corresponding horizontal aperture line on the mask 3.

Rays being emerged from horizontal pixel lines 101 (ld1), 102 (ld2), and 103 (ld3), which are shown in FIG. 9, and being incident on respective corresponding cylindrical lens portions 201 in the horizontal lenticular lens 2 are formed images on corresponding horizontal aperture lines 301 (lm1), 302 (lm2), and 303 (lm3) on the mask 3.

Similarly, rays emerged from other horizontal pixel lines are also formed images on corresponding horizontal aperture lines on the mask 3 respectively.

In addition, when conditions between intervals between the display unit 1, horizontal lenticular lens 2, and the mask 3, which will be explained later, and horizontal pitches of these three components are satisfied, for example, the display light emerged from a horizontal pixel line 101′ (ld1) and is incident on a cylindrical lens portion 203, which does not correspond to the horizontal pixel line 111, in the horizontal lenticular lens 2 is also condensed on a horizontal aperture line 311 that has the same aperture arrangement so as to correspond to the horizontal pixel line ld1 (horizontal pixel line equivalent to the horizontal pixel line 101′) though not corresponding to the horizontal pixel line 101′ on the mask 3. Hence, a problem never occurs in the stereoscopic image display. Namely, it is not possible that the display light emerged from the horizontal pixel line 101′ is incident on horizontal aperture lines 312 and 313 that do not correspond to the horizontal pixel line ld1 to reach an observation position other than the one it was intended to reach originally.

Next, relational expressions among vertical parameters concerning stereoscopic image display will be explained by using FIG. 9. In addition, the number of viewpoints is generalized as r=p·q in these relational expressions.

When the air conversion distance between the display unit 1 and horizontal lenticular lens 2 is Lv1, and the air conversion distance between the horizontal lenticular lens 2 and mask 3 is Lv2, the following relational expressions stand up:

| | |
|---|---|
| Vd:Vm = Lv1:Lv2 | (V1) |
| 2 · p · Vm:VL = Lv1 + Lv2:Lv1 | (V2) |
| 1/fv = 1/Lv1 + 1/Lv2 | (V3) |

where, Vd is a pitch of the pixels in the vertical direction on the display unit 1, Vm is a pitch of the apertures in the vertical direction on the mask 3 and fv is a focal length of each cylindrical lens portion, constituting the horizontal lenticular lens 2, in the vertical direction.

In addition, as a relational expression that connects a horizontal parameter, concerning the above-described stereoscopic image display, with the vertical parameters, the following expression stands up in regard to positions of the display unit 1 and mask 3:

| | |
|---|---|
| Lv1 + Lv2 = L1 | (hv1) |

In addition, since a cylindrical lens portion constituting the horizontal lenticular lens 2 usually has aberration, there is a possibility of causing a crosstalk because an image formed on a horizontal aperture line by light emerged from each horizontal pixel line becomes unclear to leak into upper and lower horizontal aperture lines. In regard to this, it is possible to prevent the light from leaking to the upper and lower horizontal aperture lines by reducing a vertical opening ratio of each aperture in the mask 3.

(Embodiment 2)

Though a system using the monochrome display unit 1 is described in the above-described Embodiment 1, the present invention can be also applied in the case of using a color display unit where one pixel is constituted by three colors of subpixels that are R(red), G(green), and B(blue). However, there is a possibility of causing so-called color breakup (color separation) on an observation plane when the subpixels of R, G, and B are arranged in a vertically striped manner as it is like the display unit in Embodiment 1.

What is necessary to suppress color breakup is to modify the structure as follows. That is, in each pixel block on the display unit, a linage p of the number of viewpoints (pixels corresponding to different viewpoints in a pixel block) r=p·q is made an integral multiple of the number of color divisions, c (in many cases, it is 3 corresponding to R, G, and B). And, the number of columns, q is made not to be an integral multiple of the number of color divisions, c.

In addition, the assignment of the viewpoints is not performed by pixel like Embodiment 1, but is performed by subpixel including the division of the color display.

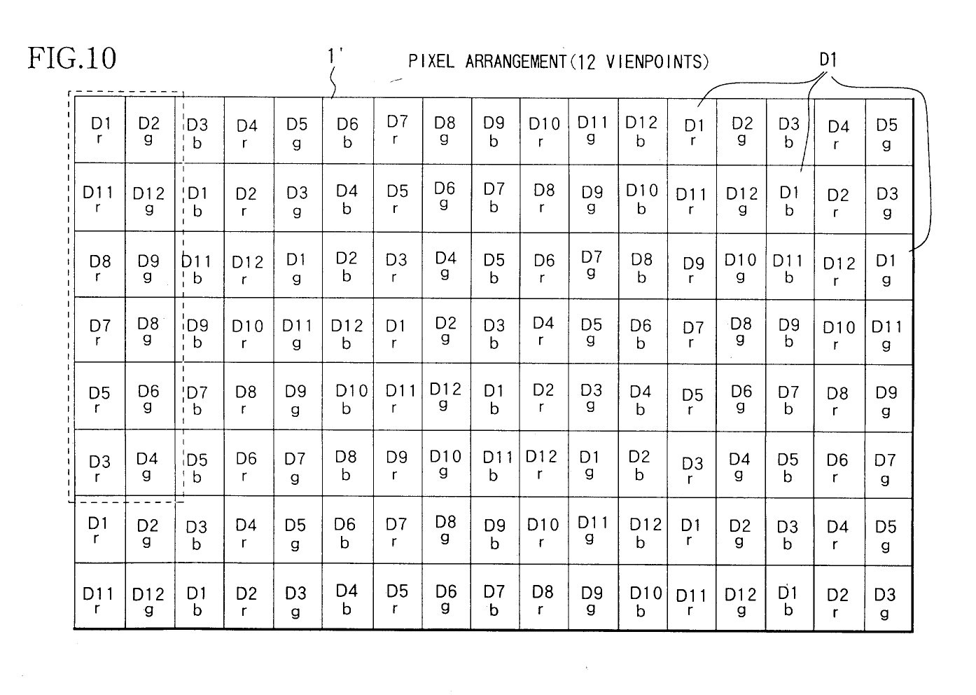

FIG. 10 is a front view showing how to display original images, corresponding to 12 viewpoints, to respective subpixels when the stereoscopic image with 12 viewpoints that P=6, q=2, and r=1 is displayed on a color display unit where subpixels of R, G, and B are arranged in a vertically striped manner.

As described above, in this t, the assignment of viewpoints is not performed by pixel, but is performed by subpixel including the division of color display. Except making the number of viewpoints (observation position) 6·2=12, the assignment of the original images to pixels and aperture positions in the mask that corresponding to these are similar to those in Embodiment 1.

That is, in a display unit 1′, it is made that subpixels D1 to D12 are cyclically and repeatedly arranged in each horizontal pixel line in this order, the subpixels D1 to D12 shift horizontally by 2(=q) subpixels every other horizontal pixel line in the vertical direction, and the same subpixel arrangement appears every 6(=p) lines in the vertical direction.

Owing to this, a pixel block where 12 subpixels D1 to D12 that are enclosed by dotted lines in FIG. 10 are arranged in a 6 pieces (rows)×2 pieces (columns) matrix is formed, and the display unit 1′ is formed in a shape of arranging a plurality of these pixel blocks vertically and horizontally.

However, as for the arrangement of the above-described 12 subpixels in each pixel block, there are a pixel block where the subpixels D1 and D2 become a top row, a pixel block where the subpixels D3 and D4 become a top row, a pixel block where the subpixels D5 and D6 become a top row, a pixel block where the subpixels D7 and D8 become a top row, a pixel block where the subpixels D9 and D10 become a top row, and a pixel block where the subpixels D11 and D12 become a top row.

Then, by using an individual subpixel in each of the plurality of these pixel blocks (that is, a subpixel group of D1, a subpixel group of D2, a subpixel group of D3, a subpixel group of D4, a subpixel group of D5, a subpixel group of D6, a subpixel group of D7, a subpixel group of D8, a subpixel group of D9, a subpixel group of D10, a subpixel group of D11, and a subpixel group of D12), twelve images corresponding to the above-described twelve viewpoints are displayed.

Here, subpixels for three colors of R, G, and B (for example, D1r, D1g, and D1b) are included in each subpixel group described above. Hence, when subpixels D1 and D2 included in a top horizontal pixel line and a fourth horizontal pixel line from the top row among the plurality of above-described horizontal pixel lines are a red subpixel D1r and a green subpixel D2g respectively, subpixels D1 and D2 included in second and fifth horizontal pixel lines are a blue subpixel D1b and a red subpixel D2r. In addition, subpixels D1 and D2 included in third and sixth horizontal pixel lines are a green subpixel D1g, and a blue subpixels D2b. In this manner, the color of light emerged from a subpixel is different every other horizontal pixel line.

Owing to this, as shown in FIG. 10, for example, subpixels D1r, D1g, and D1b of D1 that display respective colors of R, G, and B corresponding to an observation position E1 are arranged adjacently one another for one color image to be able to be displayed. At the same time, rays of display light form these subpixels reach the same observation position E1 on the observation plane, and hence, the color separation does not arise in the observation plane. In addition, pixels emitting the light that reaches other observation positions are also similar to the above.

Furthermore, the cylindrical lens portion constituting a horizontal lenticular lens (not shown) is constituted so as to make the display light from six (=p) horizontal pixel lines in the display unit 1′ form images on six horizontal aperture lines corresponding on the mask (not shown).

In addition, all the relational expressions explained in Embodiment 1 also stand up in the case of p=6, q=2, and r=12.

(Embodiment 3)

The present invention leads display light to a different observation position on the observation plane if the horizontal pixel lines are different even if horizontal positions of pixels of each horizontal pixel line are the same, by making an arrangement pattern of apertures in the mask correspond to each horizontal pixel line where the order of pixel arrangement is mutually shifted in the image display unit (display unit). Then, the present invention relieves the degradation of resolution in either the horizontal direction or the vertical direction by also distributing the degradation in another direction, by distributing display light form respective pixels of a pixel block arranged in a matrix in the image display unit to respective observation positions in a matrix-like pattern.

Hence, it is possible to perform the distribution of display light from pixels to the observation positions, which is explained in Embodiment 1, by some different methods, and hence, distribution methods of display light different from that in Embodiment 1 will be explained in this embodiment and the following Embodiment 4.

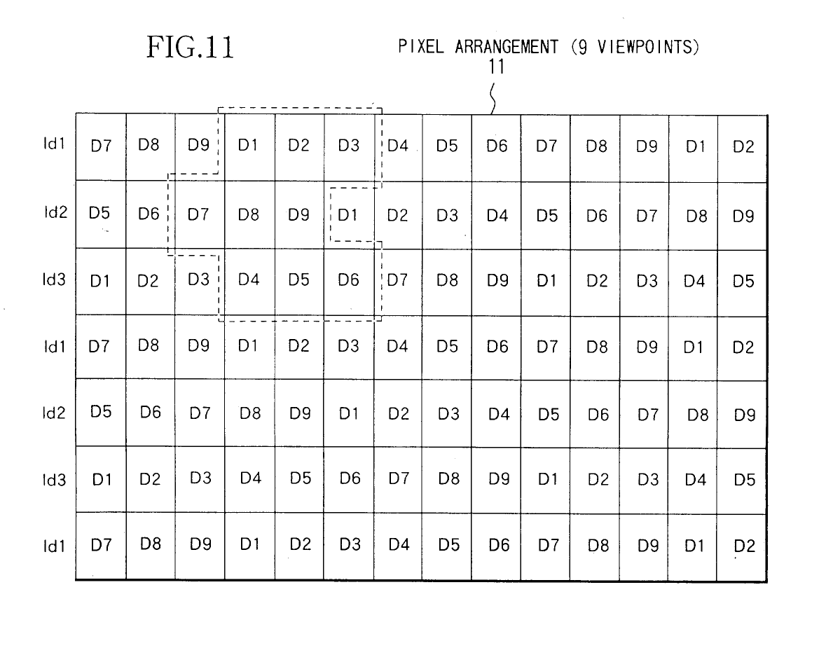

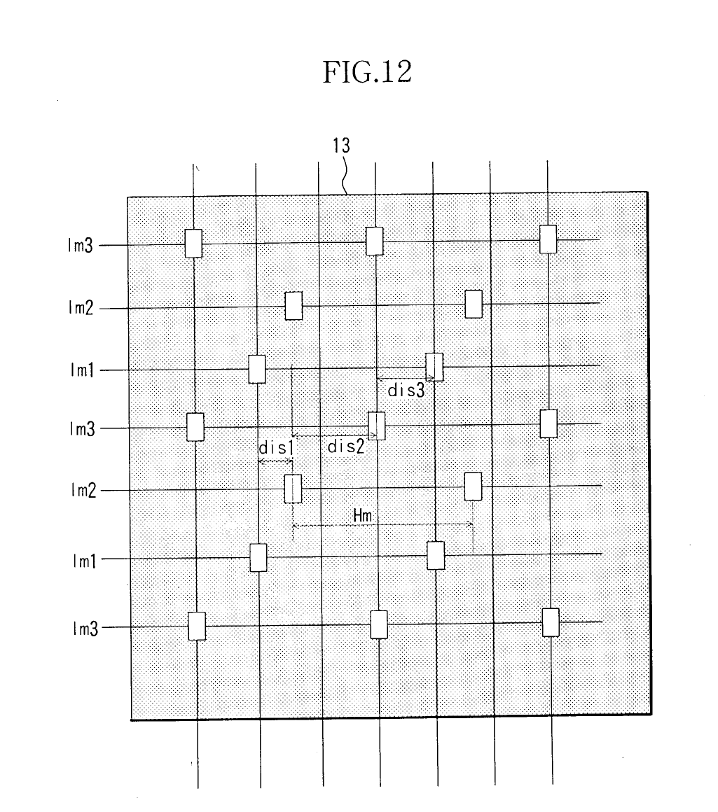

Points different from Embodiment 1 will be emphatically explained in this embodiment. As shown in FIG. 11, a stereoscopic image display apparatus according to this embodiment is constituted by a display unit 11 where pixel arrangement different from that in Embodiment 1 is performed, a horizontal lenticular lens similar to that in Embodiment 1, and, a mask 13 in which an arrangement pattern of apertures is different from that in Embodiment 1 and which is shown in FIG. 12.

FIG. 11 shows pixel arrangement on the display unit 11 in the case of p=3, q=3, and r=9.

In Embodiment 1, the case of shifting horizontal positions of pixels by three pixels, which is the number of lines, q, every horizontal pixel line as shown in FIG. 2 is explained. But, pixels D1 to D9 are arranged in this embodiment so that a first horizontal pixel line (ld1) and a second horizontal pixel line (ld2) may shift by two pixels from each other, the second horizontal pixel line (ld2) and a third horizontal pixel line (ld3) may shift by four pixels from each other, and the third horizontal pixel line (ld3) and a first horizontal pixel line (ld1) may shift by three pixels form each other. Hereafter, this pattern is repeated.

Owing to this, each pixel block that is enclosed by dotted lines in the drawing and includes nine (=3×3) pixels form D1 to D9 is formed, and the display unit 11 is formed in a shape that a plurality of these pixel blocks is arranged vertically and horizontally.

It is possible to lead rays of display light from respective pixels to observation positions corresponding respectively by making an arrangement pattern of apertures on the mask 13 differ from that in Embodiment 1 even if such a method of shifting pixels in horizontal positions is performed.

FIG. 12 is a front view showing an arrangement pattern of apertures in the mask 13 in this embodiment. A horizontal shift amount dis1 between a horizontal aperture line lm1 in the mask 13 corresponding to a horizontal pixel line ld1, and a horizontal aperture line lm2 corresponding to a horizontal pixel line ld2 is Hm/9×2 to a horizontal interval Hm between apertures in one horizontal aperture line. Similarly, a shift amount dis2 between the apertures of the horizontal aperture line lm2 and apertures of a horizontal aperture line lm3 is Hm/9×4, and a shift amount dis3 between the apertures of the horizontal aperture line lm3 and apertures of a horizontal aperture line lm1 is Hm/9×3. Hereafter, this pattern is repeated. Here, 9=r=p·q.

Since pixel arrangement corresponding to the same observation positions becomes asymmetric as an entire screen when a stereoscopic image display apparatus is constituted in this manner, there is a possibility of making the degradation of resolution not further stand out.

In addition, among relational expressions explained in Embodiment 1, all the relational expressions other than the relational expression h4 concerning a horizontal shift amount of apertures hold in this embodiment.

(Embodiment 4)

Though the case that original images to r (=p·q) pieces of viewpoints (observation positions) are displayed by r pieces of pixels lined up horizontally is explained in the above-described Embodiments 1 to 3, it is also possible to adopt structure different from these. Points different from Embodiments 1 to 3 will be emphatically explained also in this embodiment.

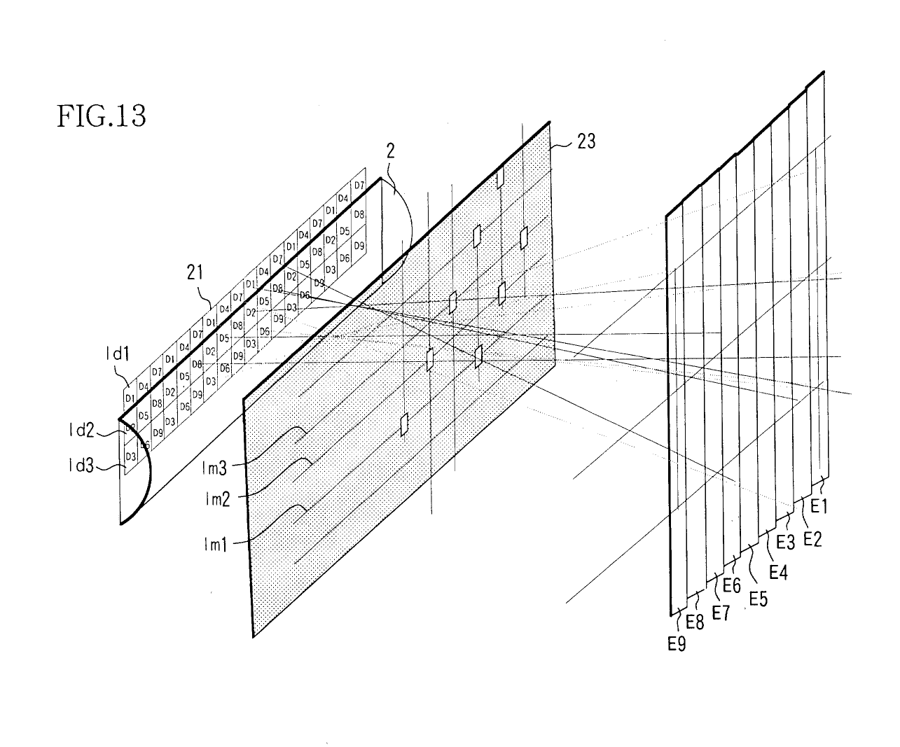

FIG. 13 shows the structure of a stereoscopic image display apparatus according to this embodiment, and the same reference characters are assigned to components common to those in other embodiments.

The stereoscopic image display apparatus according to this embodiment is constituted by using a display unit 21, the horizontal lenticular lens 2, and a mask 23.

Also in this embodiment, horizontal pixel lines ld1, ld2, and ld3 on the display unit 21 are formed images on horizontal aperture lines lm1, lm2, and lm3 on the mask 23, which correspond respectively, by the horizontal lenticular lens 2.

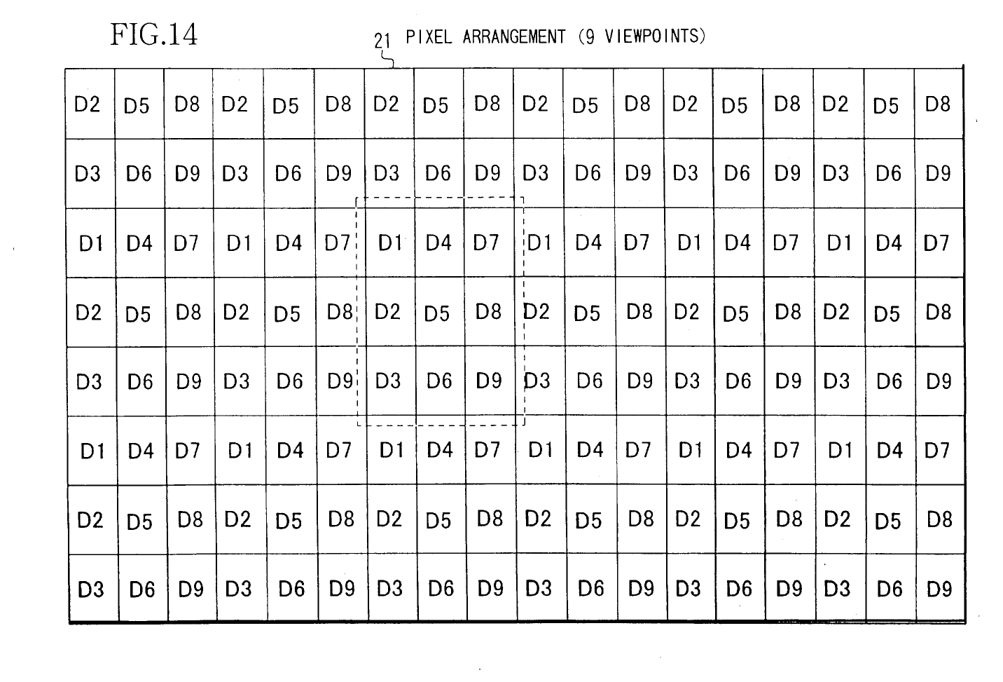

FIG. 14 shows pixel arrangement in the display unit 21 according to this embodiment in the case of p=3, q=3, and r=9.

In this embodiment, three pieces (=q) of pixels every three (=p) pixels including a pixel D1, that is, D1, D4, and D7 are cyclically and repeatedly arranged in this order among pixels D1 to D9 on the horizontal pixel line ld1, and three pieces of pixels every three pixels including a pixel D2, that is, D2, D5, and D8 are cyclically and repeatedly arranged in this order among pixels D1 to D9 on the horizontal pixel line ld2. In addition, three pieces of pixels every three pixels including a pixel D3, that is, D3, D6, and D9 are cyclically and repeatedly arranged in this order among pixels D1 to D9 on the horizontal pixel line ld3.

That is, when the number of observation positions is r (integer), q (integer) pieces of pixels, which are different from one another, among first to r-th pixels displaying first to r-th images are cyclically arranged in predetermined order in units of p(integer) lines in the vertical direction.

Owing to this, each pixel block that is enclosed by dotted lines in FIG. 14 is formed by arranging nine pixels from D1 to D9 in a matrix of three pixel (rows)×three pixels (columns), and the display unit 21 is formed in a shape that a plurality of these pixel blocks is arranged vertically and horizontally.

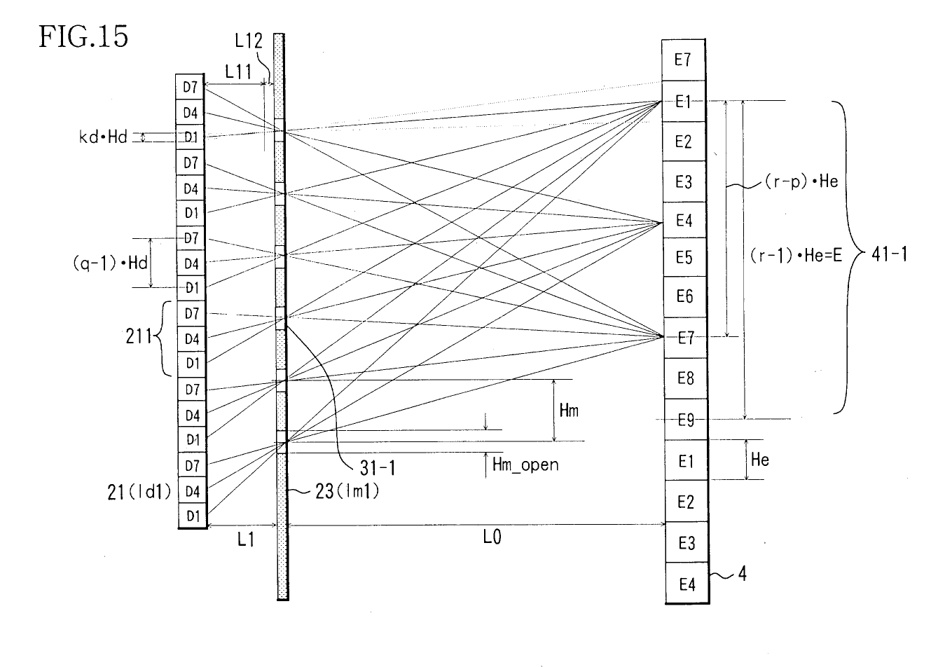

FIGS. 15, 16, and 17 show the structure, which are taken by planes including the horizontal pixel line ld1 and horizontal aperture line lm1, the horizontal pixel line ld2 and horizontal aperture line lm2, and the horizontal pixel line ld3 and horizontal aperture line lm3, and principles of stereoscopic image display of the stereoscopic image display apparatus according to this embodiment respectively. Here, the horizontal lenticular lens 2 is omitted in these drawings.

In FIG. 15, rays of display light from pixels D1, D4, and D7 in an area 211 on the horizontal pixel line ld1 pass an aperture 31-1 in the mask 23, and reach observation positions E1, E4, and E7 in an area 41-1 corresponding respectively on the observation plane 4.

As explained later in detail, by properly choosing an opening ratio kd of pixels of the display unit 21 and aperture width Hm open of the mask 23, rays of display light from the pixels D1, D4, and D7 cannot reach observation positions other than the observation positions E1, E4, and E7 corresponding on the observation plane 4 because of being shielded by a light shielding portion of the mask 23.

Rays of display light from pixels D1, D4, and D7 in areas other than the area 211 on the horizontal pixel line ld1 also pass apertures in the mask 23, and reaches the observation positions E1, E4, and E7 corresponding respectively not to reach other observation positions.

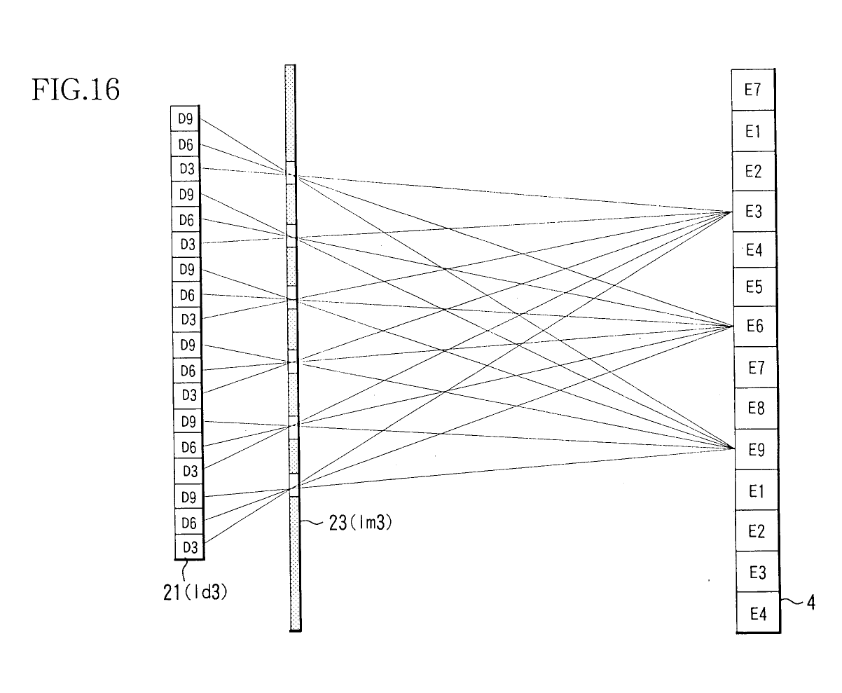

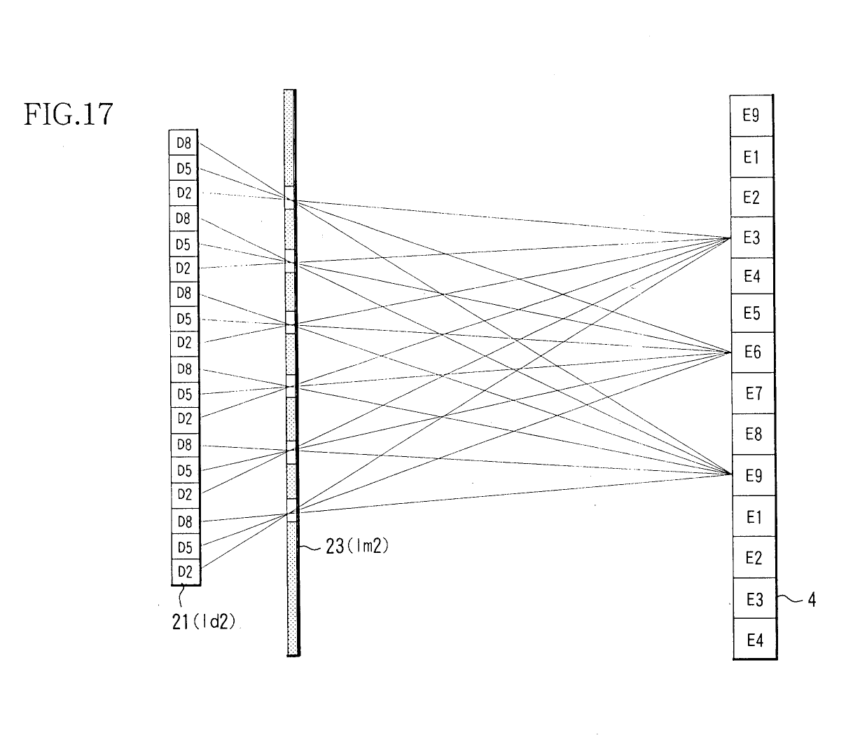

As shown to FIGS. 16 and 17, pixels D2, D5, and D8, and pixels D3, D6, and D9 that correspond to observation positions E2, E5, and E8, and, E3, E6, and E9 respectively on horizontal pixel lines ld2 and ld3 reach the observation positions E2, E5, and E8, and E3, E6, and E9 through apertures whose horizontal positions in horizontal aperture lines lm2 and lm3 corresponding respectively in the mask 23 shift mutually never to reach other observation positions.

Here, further detailed explanation will be performed by using FIG. 15. The center distance between pixels D1 and D7 is 2·Hd corresponding to (q−1)·Hd, and hence, when the width of each observation position is He, separation width E between both pixels D1 and D7 on the observation plane 4 is 6·He corresponding to (r−p)·He.

“He” is associated by the separation width E of r viewpoints and the following expression stands up:

| | |
|---|---|
| E = (r − 1) · He | (h100) |

Hence, E=8·He in this embodiment.

At this time, the following relational expression stands up:

(q−1)·Hd:(r−p)·He=L1:L0 (h101)

An interval Hm between apertures in the mask 23 satisfies the following relation:

| | |
|---|---|
| q · Hd:Hm = L1 + L0:L0 | (h102) |

Moreover, conditions for display light from the pixel D1 being accommodated within the observation position E1 in the observation plane 4 not to leak to adjacent observation positions are as follows:

| | |
|---|---|
| kd · Hd:He = L11:L12 + L0 | (h103) |
| kd · Hd:Hm_open = L11:L12 | (h104) |
| L11 + L12 = L1 | (h105) |

Here, L11 and L12 are optical conversion distance from the display unit 21 and optical conversion distance from the mask 23 to a point where straight lines connecting both ends of an effective portion (when a horizontal opening ratio of a pixel is kd, width is kd·Hd) of each pixel on the display unit 21 to both ends of an observation position (width: He) on the observation plane 4 intersect with each other.

Resolving expression h105 from expression h100,

L1=Hd·L0·(r−1)/(p·E)

He=E/(r−1)

Hm=Hd·E·r/(Hd·(r−1)+p·E)

Hm_open=Hd·E·(1−kd·p)/(Hd·(r−1)+p·E)

So long as these expressions are satisfied, rays of display light from pixels the D1, D4, and D7 that are shown in FIG. 15 reach only the observation positions E1, E4, and E7 respectively among the observation positions of E1 to E9 corresponding to nine viewpoints never to reach other observation positions.

In addition, similarly also in the sections shown to FIGS. 16 and 17, rays of display light from the pixels D2, D5, and D8 and pixels D3, D6, and D9 reach only the observation positions E2, E5, and E8, and the observation positions E3, E6, and E9 respectively among the observation positions E1 to E9 corresponding to nine viewpoints never to reach other observation positions

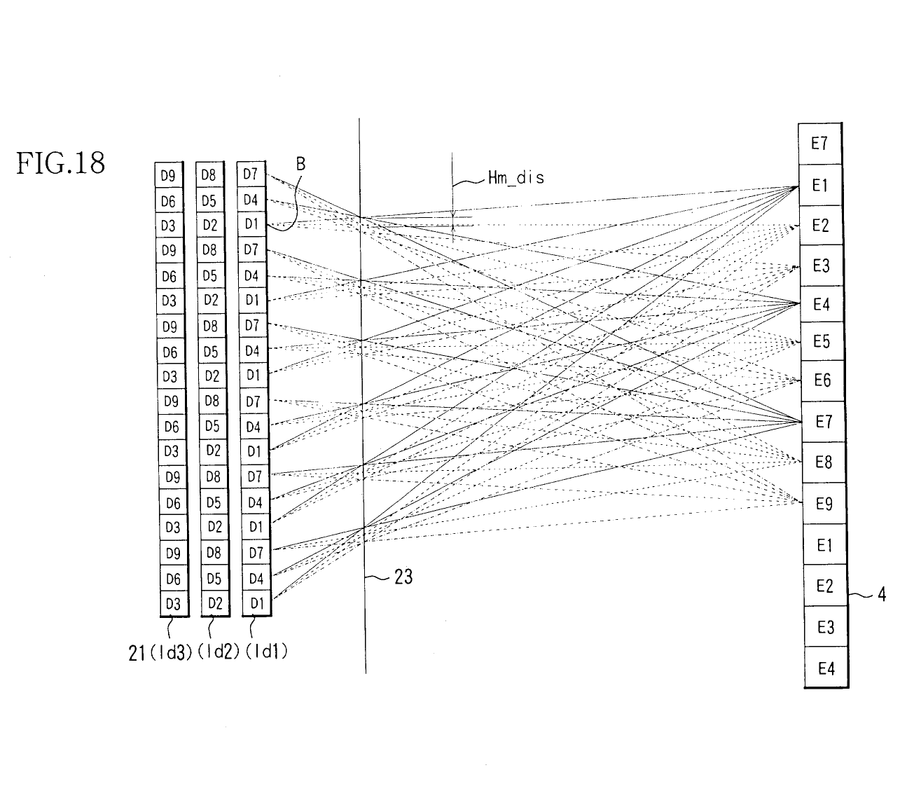

FIG. 18 shows the sections, shown in FIGS. 15 to 17, with superimposing them. However, three horizontal pixel lines ld1, ld2, and ld3 in the display unit 21 are displayed with being shifted longitudinally.

A shift amount Hm_dis between positions of apertures in between horizontal aperture lines lm1, lm2, and lm3 in the mask 23 will be explained by using FIG. 18. Here, the horizontal lenticular lens 2 is omitted in FIG. 18.

In this embodiment, a pixel in the horizontal pixel line ld2 having the same horizontal position as a pixel in the horizontal pixel line ld1 corresponds to the observation position shifted by one, to the pixel in the horizontal pixel line ld1 on the display unit 21.

Hence, a ray of light emerged from one point of a pixel in FIG. 18, for instance, a point B reaches the observation position E1 on the observation plane 4 when the pixel is a pixel on the horizontal pixel line ld1, or reaches the observation position E2 when the pixel is a pixel on the horizontal pixel line ld2. When paying attention to these two rays of light, the following relation can be geometrically obtained:

| | |
|---|---|
| Hm_dis:He = L1 + L0:L1 | (h106) |

Resolving the above-described expression h106 from expression h100 and h105, the following relation can be obtained:

Hm_{—}dis=Hd·E/(Hd·(r−1)+p·E)=Hm/r

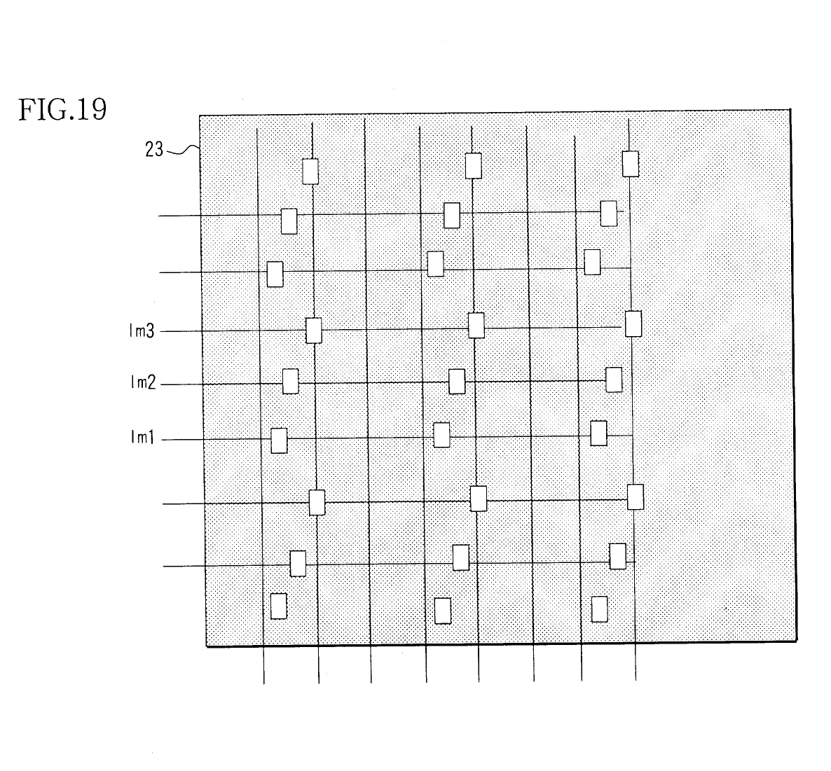

FIG. 19 shows an arrangement pattern of apertures in the mask 23 in this embodiment.

(Embodiment 5)

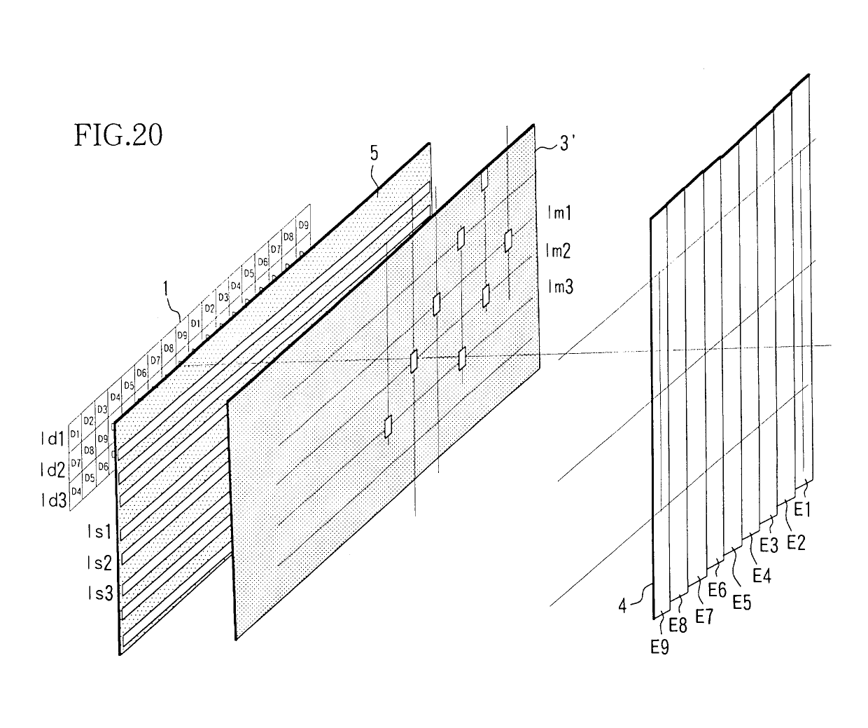

FIG. 20 shows the structure of a stereoscopic image display apparatus that is Embodiment 5 of the present invention. This embodiment without using a horizontal lenticular lens is different from the above-described Embodiments 1 to 4 from the viewpoint of using a second mask having horizontal slits for limiting ranges where rays diverge in the vertical direction. In addition, the same reference characters are assigned in this embodiment to components common to those in the above-described Embodiments 1 to 4.

In the stereoscopic image display apparatus according to this embodiment, a second mask 5 having horizontal slit apertures is provided between the display unit 1 and a mask 3′. This embodiment is the stereoscopic image display apparatus having nine viewpoints composed of p=3, q=3, and r=9.

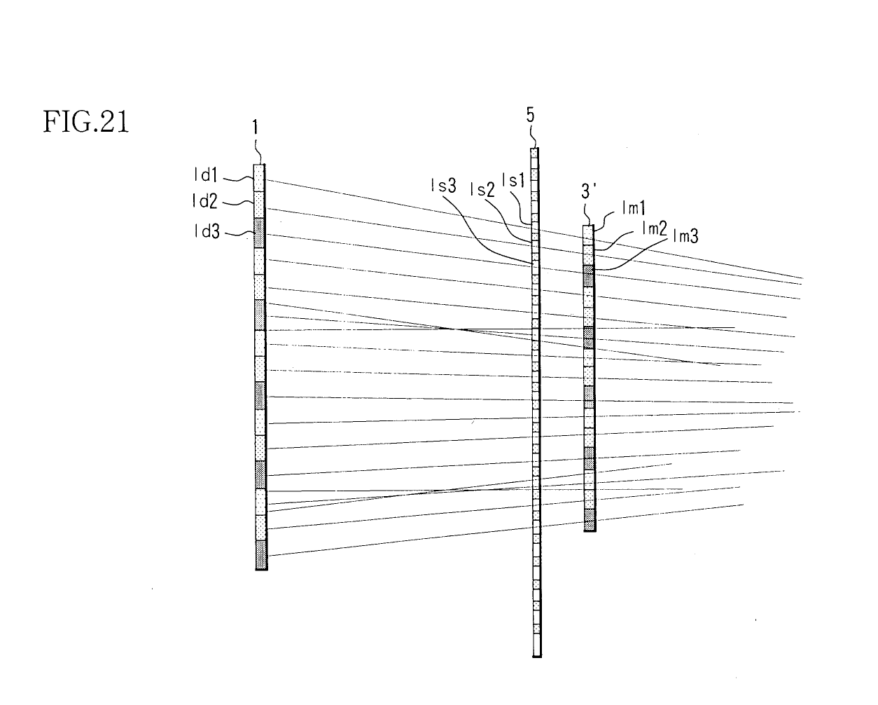

FIG. 21 is a vertical section for explaining an optical action in the vertical direction in this embodiment. Any one of the methods explained in Embodiments 1 to 4 can be used for the assignment of pixels to nine viewpoints.

Horizontal slit apertures of the second mask 5 are provided with corresponding to respective horizontal pixel lines of the display unit 1 and prevents display light from being incident on upper and lower horizontal aperture lines of the horizontal aperture line in the mask 3′ corresponding to each horizontal pixel line by suppressing the diffusion of the display light that is emerged from each horizontal pixel line and diverges also in the vertical direction.

That is, as shown in FIG. 21, rays of display light from the horizontal pixel lines ld1, ld2, and ld3 are incident on a series of horizontal aperture lines lm1, lm2, and lm3 on the mask 3′ respectively that correspond to three consecutive horizontal pixel lines ld1, ld2, and ld3 on the display unit 1 respectively. Nevertheless, horizontal slit apertures ls1, ls2, and ls3 that correspond to respective horizontal pixel lines and respective horizontal aperture lines are provided in the second mask 5 so that rays of those display light should not be incident on horizontal aperture lines adjacent in the upper and lower directions to the above-described corresponding horizontal aperture line.

Here, in the above-described Embodiments 1 to 4, by making rays of display light from a horizontal pixel line on a display unit form images on a mask by a horizontal lenticular lens, the display light from each horizontal pixel line is prevented from reaching a horizontal aperture line other than a corresponding horizontal aperture line in the mask. Hence, the order of a series of horizontal pixel lines, for example, horizontal pixel lines ld1, ld2, and ld3, and horizontal aperture lines lm1, lm2, and lm3 in the mask, which correspond to them, in the case of p=3, is reversed in the vertical direction because of the optical action of a cylindrical lens portion that constitutes a horizontal lenticular lens.

Against this, in this embodiment, by using the second mask 5, the order of a series of horizontal pixel lines (for example, ld1, ld2, and ld3) in the vertical direction coincides with the order of horizontal aperture lines (for example, lm1, lm2, and lm3) on the mask 3′, which correspond to these respective horizontal pixel lines, in the vertical direction.

Owing to this, though the arrangement order of the horizontal aperture lines lm1, lm2, and lm3 in the mask 3′ differs from that of each mask in Embodiments 1 to 4 in the vertical direction, this is just vertical rearrangement of the horizontal aperture lines in each mask in Embodiments 1 to 4. Hence, all the horizontal relational expressions of arrangement patterns of apertures in the mask 3′ that are explained in Embodiments 1 to 4 stand up.

(Embodiment 6)

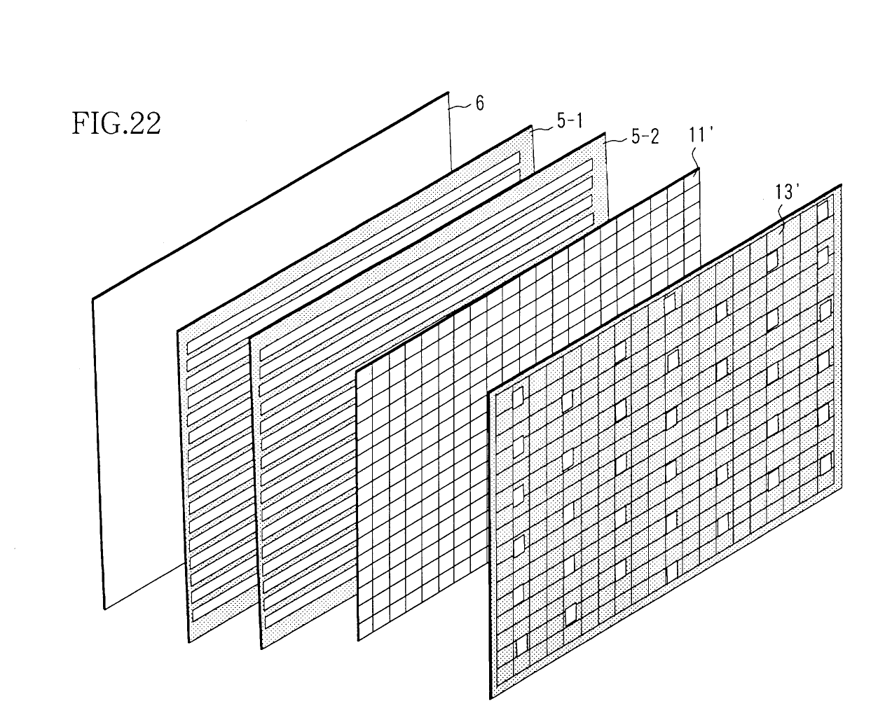

FIG. 22 shows the structure of a stereoscopic image display apparatus that is Embodiment 6 of the present invention. Since this embodiment has a lot of points similar to those in Embodiment 3, description will be emphatically performed only for points different from those in Embodiment 3.

In this embodiment, a transmissive image display unit, for instance, a transmissive LCD is used as a display unit 11′. Between a back light panel 6 and the LCD 11′, two second masks 5-1 and 5-2 (limiting members) 5-1 and 5-2 are arranged, the two second masks having horizontal slit apertures for suppressing the vertical diffusion of display light from the back light panel 6 that is incident on a horizontal pixel line on the LCD 11′.

A mask 13′ similar to that in Embodiment 3 is provided in front of the LCD 11′, the mask 13′ having horizontal aperture lines with arrangement patterns of apertures corresponding to the arrangement of pixels in respective horizontal pixel lines on the LCD 11′.

Though illumination light from the back light panel 6 is incident on the LCD 11′ with being limited for vertical divergence by the second masks 5-1 and 5-2 having horizontal slit apertures, this incident display light diffuses a little by the pixel structure of the LCD 11′ when penetrating the LCD 11′.

Nevertheless, in this embodiment, since a spacing between the LCD 11′ and mask 13′ is sufficiently small, the display light incident from each horizontal pixel line on horizontal aperture lines other than a horizontal aperture line corresponding to the horizontal pixel line are few in the mask 13′. Hence, a problem such as a crosstalk doesn't arise.

In addition, in the case that setting of a direction of horizontal display light for stereoscopic image display is performed by setting of a direction of illumination light incident on the transmissive display unit, a crosstalk in an observation plane that is solved by the present invention, is caused by the diffusion caused by the pixel structure of an LCD arises because display light shifts from a set observation position since a change of an angle of the display light caused by scattering becomes a large horizontal positional error on the observation plane on the way of proceeding in comparatively long distance, for example, about 600 mm, from a surface of the display unit to the observation plane after the display light to be directed is scattered by the pixel structure of the transmissive display unit. Nevertheless, this embodiment is different from this case.

(Embodiment 7)

In this embodiment, in particular, structure will be explained, the structure that one cylindrical lens constituting a horizontal lenticular lens corresponds to one horizontal pixel line, and display light from the horizontal pixel line forms images in the vertical direction on one horizontal aperture line in a mask.

In Embodiment 1 and the like, structure is explained, the structure that the number of viewpoints is r, and the width of one cylindrical lens constituting a horizontal lenticular lens corresponds to p lines of horizontal pixel lines in the case of regarding a pixel arrangement matrix, which corresponds to respective viewpoints that are arranged on the display unit, as r=p (rows)×q (columns). In this case, rays of display light from p lines of horizontal pixel lines corresponding to one cylindrical lens form images in the vertical direction on p lines of horizontal aperture lines in the mask, corresponding respectively, by the cylindrical lens. On the other hand, structure will be explained in this embodiment, the structure that a cylindrical lens corresponding to one horizontal pixel line is provided, and display light from the horizontal pixel line forms images in the vertical direction on one horizontal aperture line on a mask.

In this embodiment, points different from Embodiment 1 will be emphatically explained. A stereoscopic image display apparatus according to this embodiment is constituted by a display unit 1″ where predetermined pixel arrangement is performed, a horizontal lenticular lens 2″ where one cylindrical lens corresponding to one horizontal pixel line on the display unit 1″ is arranged in the vertical direction, and a mask 3″ having an arrangement pattern of apertures determined in consideration of pixel arrangement on the above-described display unit 1″ etc.

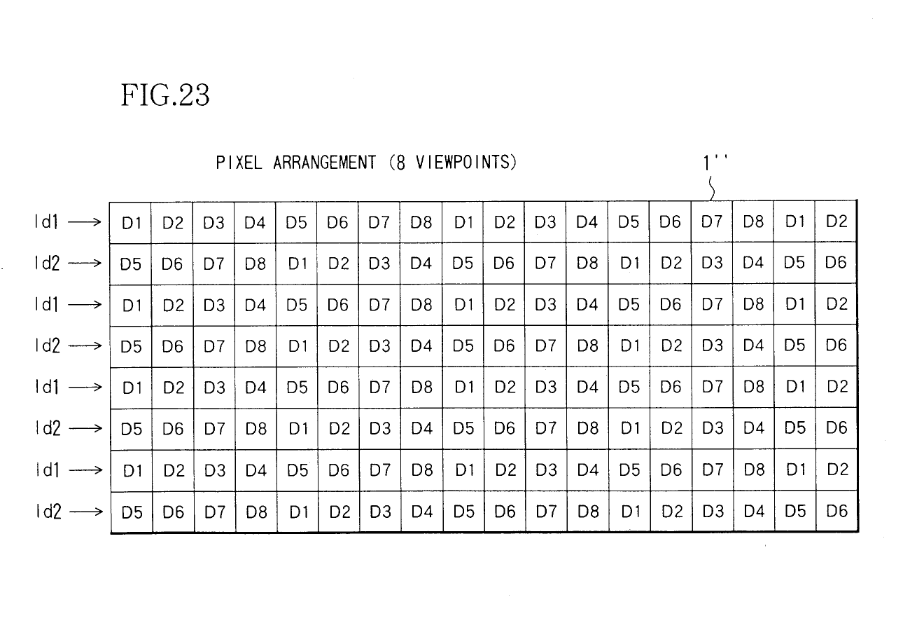

FIG. 23 is a front view showing an example of the arrangement of pixels displaying images that are displayed in the display unit used in this embodiment and correspond to respective viewpoints. In this embodiment, since each cylindrical lens of the horizontal lenticular lens 2″ corresponds to one horizontal pixel line, the vertical width of each cylindrical lens does not relate to the number of rows (p) included in each matrix. Nevertheless, as explained later, in order to prevent images, corresponding to respective observation positions, from being mixed, it is preferable to arrange pixels corresponding to respective viewpoints in a matrix shape that is determined by the positional relation among respective components of the stereoscopic image display apparatus according to the present invention.

In FIG. 23, the matrix arrangement regarded as p=2 and q=4 for the number of viewpoints r(=8) is formed. That is, the matrix arrangement is formed by shifting horizontal positions by four (=q) pixels every other horizontal pixel line and making two (=p) lines of horizontal pixel lines a unit in the vertical direction. In other words, horizontal pixel lines with the same pixel arrangement every other horizontal line are repeatedly arranged like ld1 and ld2 in FIG. 23.

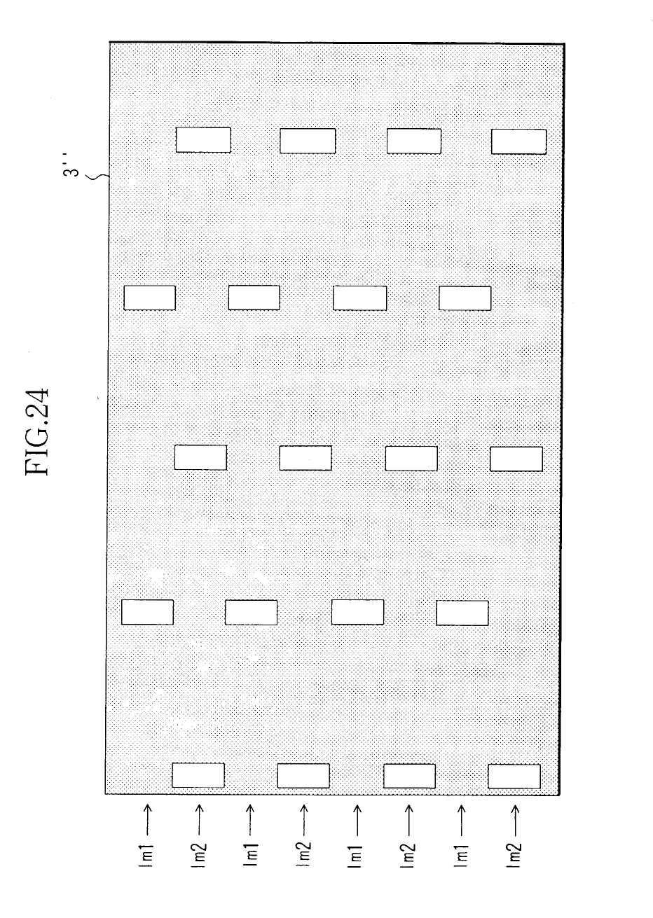

FIG. 24 is a front view showing an arrangement pattern of apertures in the mask 3″ in this embodiment. Apertures on a horizontal aperture line lm1 among horizontal aperture lines on the mask 3″ are arranged in positions to allow rays of display light from pixels in the horizontal pixel line ld1 in FIG. 23 to reach observation positions in an observation plane 4 that correspond to the viewpoints of the pixels. In addition, apertures on a horizontal aperture line lm2 are arranged in positions to allow rays of display light from pixels in the horizontal pixel line ld2 to reach the observation positions in the observation plane 4 that correspond to the viewpoints of the pixels. Since the horizontal pixel lines ld1 and ld2 on the display unit 1″ are arranged alternately as shown in FIG. 23, the horizontal aperture lines lm1 and lm2 with the aperture pattern corresponding respectively are alternately repeated. In addition, since corresponding pixels are arranged in the horizontal pixel lines ld1 and ld2 with being horizontally shifted, positions of apertures on the horizontal aperture line lm1 and those on lm2 shift horizontally.

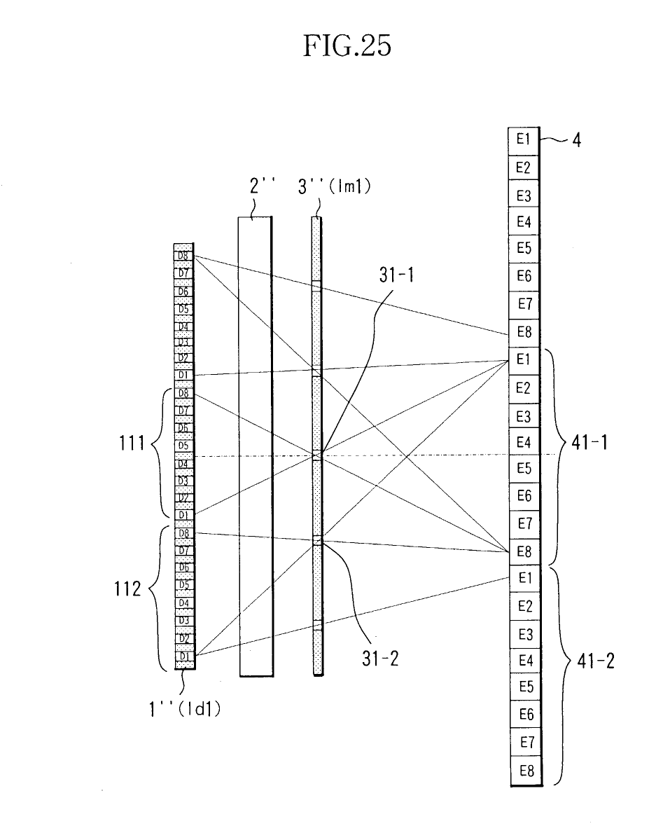

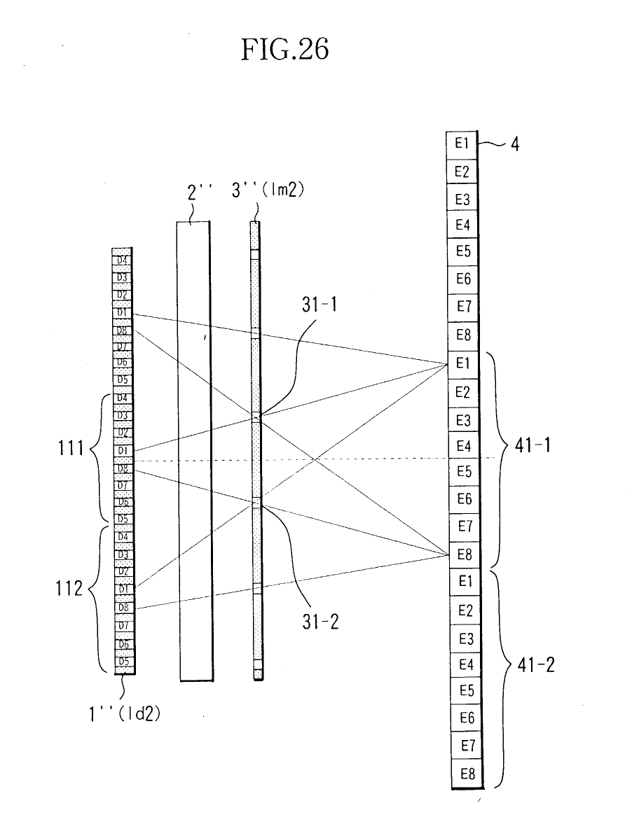

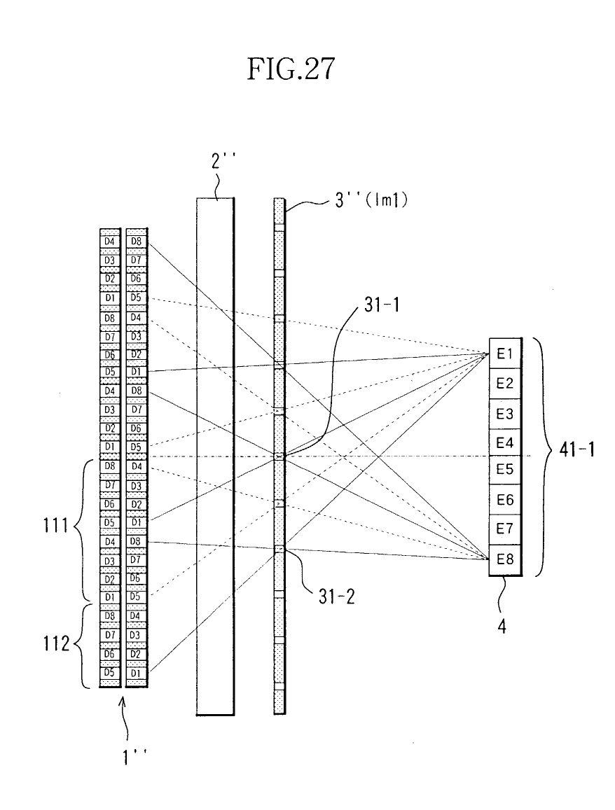

FIGS. 25 to 27 are schematic diagrams showing the relation among respective pixels on the display unit 1″, apertures in the mask 3″, and observation positions on the observation plane 4, respectively. FIG. 25 is a horizontal sectional view corresponding to the horizontal pixel line ld1 in FIG. 23 and the horizontal aperture line lm1 in FIG. 24. In addition, similarly, FIG. 26 is a horizontal sectional view corresponding to the horizontal pixel line ld2 and the horizontal aperture line lm2. FIG. 27 is a diagram drawn by superimposing FIG. 25 and FIG. 26.

It can be seen that the observation of a stereoscopic image with eight viewpoints is possible since rays of display light from pixels showing parallax images corresponding to observation positions E1 to E8 reaches only the observation positions E1 to E8 respectively in any pair of a horizontal pixel line and a horizontal aperture line by arranging the horizontal pixel lines ld1 and ld2, and the respectively corresponding horizontal aperture lines lm1 and lm2 in the mask 3″, as shown in each diagram.

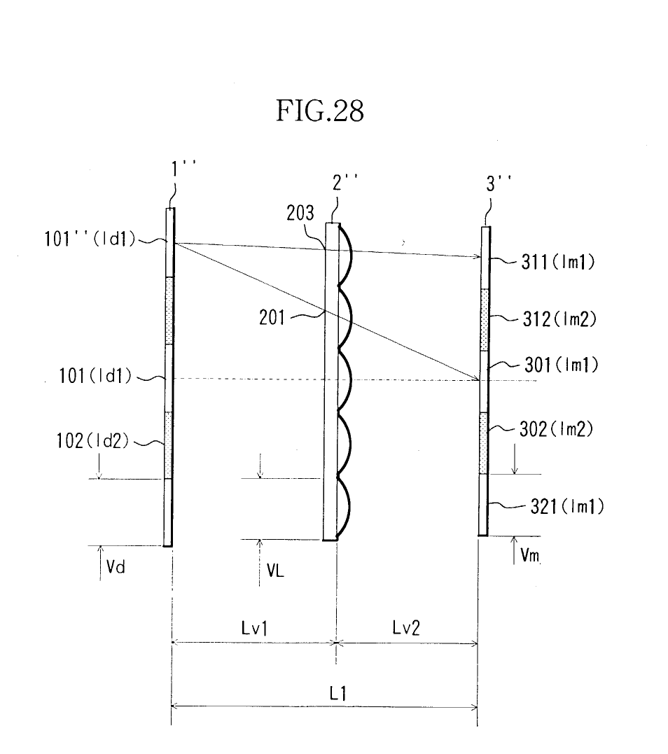

FIG. 28 is a vertical sectional view for explaining the optical action of the horizontal lenticular lens 2″ in this embodiment. An individual cylindrical lens constituting the horizontal lenticular lens 2″ corresponds to one horizontal pixel line, and forms images in the vertical direction on the horizontal aperture line corresponding to the horizontal pixel line. In FIG. 28, a horizontal pixel line 101″ and a horizontal aperture line 311 of the mask 3″ corresponds to a cylindrical lens 203 constituting the horizontal lenticular lens 2″, and the cylindrical lens 203 makes rays of display light from the horizontal pixel line 101″ forms images in the vertical direction on a horizontal aperture line 311 in the mask 3″. In addition, the horizontal pixel line 101″ has the pixel arrangement of the horizontal pixel line ld1, and the horizontal aperture line 311 in the mask 3″ has the aperture pattern of the horizontal aperture line lm1.

In FIG. 28, a horizontal pixel line and a horizontal aperture line are arranged so as to become the same every other line, and similarly to the relation explained in Embodiment 1, they are arranged with associating a ratio of distance (Lv1) between a plane, where pixels are arranged on the display unit 1″, and the horizontal lenticular lens 2″, and distance (Lv2) between the horizontal lenticular lens 2″ and mask 3″ with a ratio of the width of the horizontal pixel line to that of the horizontal aperture line. Therefore, light incident on a cylindrical lens 201, which is a cylindrical lens not corresponding originally, from the horizontal pixel line 101″ forms images in the vertical direction on the horizontal aperture line 301 in the mask 3″ by the optical action of the cylindrical lens 201. At this time, since the horizontal aperture line 301 has the aperture pattern of lm1, the rays incident on both cylindrical lenses 201 and 203 also are incident in consequence on the horizontal aperture line lm1 in the mask 3″ that correspond to the horizontal pixel line ld1 to reach predetermined observation positions. Similarly, even if rays from respective horizontal pixel lines are incident on any cylindrical lenses constituting the horizontal lenticular lens 2″, the rays forms images in the vertical direction on the horizontal aperture lines (lm1 and lm2) in the mask 3″ that correspond to the arrangement patterns (ld1 and ld2) of parallax images in the horizontal pixel lines. Hence, the stereoscopic image display is normally performed without mutually mixing images corresponding to respective observation positions.

As described above, it is possible to accurately perform the association of optical paths to the corresponding horizontal aperture lines from respective horizontal pixel lines by making a cylindrical lens, constituting the horizontal lenticular lens 2″, correspond to one horizontal pixel line. Hence, it becomes possible to effectively prevent the mixing of images corresponding to respective observation positions, and it is possible to reduce color separation generated when color display is performed.

In addition, though the pixel arrangement in a display unit is in so-called vertical stripes in each embodiment explained above, the present invention can be also applied to the case of using a display unit with pixel arrangement other than such vertically striped pixel arrangement.

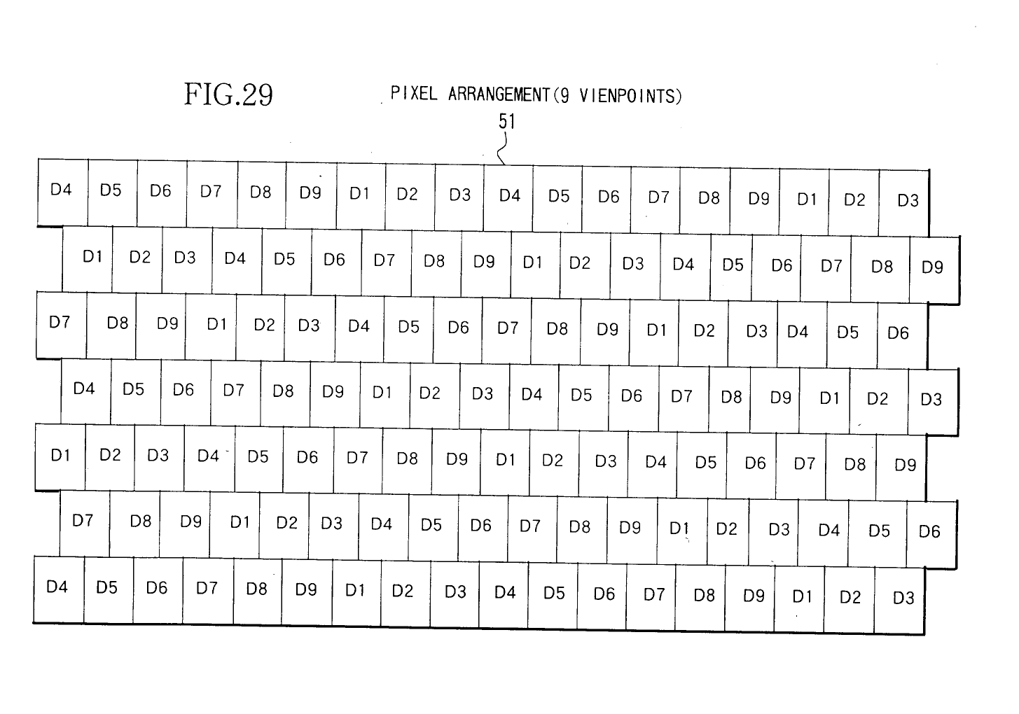

For example, it is also possible to use a display unit 51 with pixel arrangement as shown in FIG. 29. Namely, it is a display unit with so-called delta pixel arrangement where horizontal positions of pixels constituting each horizontal pixel line shift by amount corresponding to a half of one pixel to horizontal positions of pixels constituting a horizontal pixel line that is vertically adjacent.

In addition, in each of the above-described embodiments, display light are led to different observation positions on the observation plane if vertical positions are different even if horizontal positions of pixels of each horizontal pixel line are the same by making a horizontal aperture line in the mask correspond to each horizontal pixel line in the image display unit. In consequence, the embodiment relieves the degradation of resolution in either the horizontal direction or the vertical direction by also distributing the degradation in another direction by distributing display light from respective pixels in a matrix-like pattern.

Namely, all methods explained in the above-described respective embodiments stand up by modifying each aperture pattern in some extent by vertically arranging horizontal aperture lines in the mask where an aperture arrangement pattern is modified so as to correspond to the pixel arrangement in each horizontal pixel line even if the pixel arrangement of the image display unit shifts horizontally.

As explained above, according to each of the above-described embodiments, it is possible to freely select an image display unit without limiting to a transmissive image display unit, and it is possible to achieve a multiviewpoint stereoscopic image display apparatus where a crosstalk doesn't arise in the observation plane even when a transmissive image display unit with strong scattering is used.

Moreover, it is also possible to prevent color separation on the observation plane when performing color display.

While preferred embodiments have been described, it is to be understood that modification and variation of the present invention may be made without departing from the sprit or scope of the following claims.

What is claimed is:

1. A stereoscopic image display apparatus, comprising:
an image display unit in which a plurality of horizontal pixel lines is provided in a vertical direction, and pixel groups including pixels that display images corresponding to a plurality of observation positions respectively are arranged cyclically;
a mask member in which apertures to pass only a ray of light having predetermined directionality, among rays of light from the pixels are formed, and the apertures form horizontal aperture lines having predetermined cycle in a horizontal direction corresponding to the pixel groups; and
a limiting member that limits rays of light so that rays of light from a predetermined horizontal pixel line among the horizontal pixel lines may reach only horizontal aperture lines having the apertures whose horizontal positions are the same,
wherein rays of light from the pixels that display images corresponding to the respective observation positions reach predetermined observation positions through the mask member and the limiting member.

2. The stereoscopic image display apparatus according to claim 1, wherein the pixel groups in the image display unit are formed by horizontally arranging pixels displaying images corresponding to the plurality of observation positions respectively, the horizontal pixel line has a plurality of the pixel groups, and a plurality of the horizontal pixel lines is provided in the vertical direction so that the pixel groups may shift horizontally, and
the mask member has apertures each of which corresponds to each of the pixel groups.

3. The stereoscopic image display apparatus according to claim 1, wherein the pixel group in the image display unit is formed by horizontally arranging q pixels and vertically arranging p pixels in a q·p matrix, the pixels that display images corresponding to the plurality of observation positions respectively, and moreover, the pixel groups are provided on the image display unit horizontally and vertically in a matrix, and
the mask member has p apertures corresponding to each of the pixel groups in the vertical direction.

4. The stereoscopic image display apparatus according to claim 2, wherein the image display unit has c types of pixels that are cyclically arranged in the horizontal pixel line, c colors of light that are different mutually emerge from the c type of pixels, and
the number of the observation positions is not an integral multiple of the c.

5. The stereoscopic image display apparatus according to claim 3, wherein the image display unit has c types of pixels that are cyclically arranged in the horizontal pixel line, c colors of light that are different mutually emerge from the c type of pixels, and
the number q of pixels included in the pixel group in the horizontal direction is not an integral multiple of the c.

6. The stereoscopic image display apparatus according to claim 1, wherein the limiting member is an optical member in which a plurality of optical acting portions that have optical power in the vertical direction and do not have optical power in the horizontal direction are arranged in the vertical direction.

7. The stereoscopic image display apparatus according to claim 1, wherein the limiting member is a second mask member having a plurality of slit apertures, extending in the horizontal direction, arranged in the vertical direction.

8. A stereoscopic image display system, comprising:
the stereoscopic image display apparatus according to claim 1; and
an image information supplying apparatus that supplies image information, displayed in the image display unit, to the stereoscopic image display apparatus.
